(19) United States
(12) Patent Application Publication
(10) Pub. No.: US 2002/0123928 A1
(43) Pub. Date: Sep. 5, 2002

(54) Targeting ads to subscribers based on privacy-protected subscriber profiles

(76) Inventors: Charles A. Eldering, Doylestown, PA (US); John A. Schlack, Southampton, PA (US); Herbert M. Lustig, North Whales, PA (US)

Correspondence Address: EXPANSE NETWORKS, INC., 300 NORTH BROADSTREET, DOYLESTOWN, PA, 18901, US

(21) Appl. No.: 09/928,024

(22) Filed: Aug. 10, 2001

Related U.S. Application Data
(60) Provisional application No. 60/260,946, filed on Jan. 11, 2001.
(60) Provisional application No. 60/263,095, filed on Jan. 19, 2001.
(60) Provisional application No. 60/278,612, filed on Mar. 26, 2001.

(51) Int. Cl. G06F 17/60

(52) U.S. Cl. 705/14

(57) ABSTRACT

Monitoring subscriber viewing interactions, such as television viewing interactions, and generating viewing characteristics therefrom. Generating at least one type of subscriber profile from at least some subset of subscriber characteristics including viewing, purchasing, transactions, statistical, deterministic, and demographic. The subscriber characteristics may be generated, gathered from at least one source, or a combination thereof. Forming groups of subscribers by correlating at least one type of subscriber profile. The subscriber groups may correlate to elements of a content delivery system (such as head-ends, nodes, branches, or set top boxes (STBs) within a cable TV system). Correlating ad profiles to subscriber/subscriber group profiles and selecting targeted advertisements for the subscribers/subscriber groups based on the correlation. Inserting the targeted ads in place of default ads in program streams somewhere within the content delivery system (head-end, node, or STB). Presenting the targeted ads to the subscriber/subscriber group via a television.

### RELATED APPLICATIONS

This application is related to the below listed co-pending applications, all of which are incorporated in their entirety but are not admitted to be prior art.

U.S. patent application Ser. No. 09/591,577, filed on Jun. 9, 2000 entitled “Privacy-Protected Advertising System” (Atty. Docket No. T702-03);

U.S. patent application Ser. No. 09/635,539, filed on Aug. 10, 2000 entitled “Delivering targeted advertisements in cable-based networks” (Atty. Docket No. T711-03);

U.S. patent application Ser. No. 09/635,542, filed on Aug. 10, 2000 entitled “Grouping subscribers based on demographic data” (Atty. Docket No. T719-00);

U.S. patent application Ser. No. 09/635,544 filed on Aug. 10, 2000 entitled “Transporting ad characterization vectors” (Atty. Docket No. T720-00);

U.S. patent application Ser. No. 09/268,519, filed on Mar. 12, 1999 entitled “Consumer Profiling System” (Atty. Docket No. T706-00);

U.S. application Ser. No. 09/204,888, filed on Dec. 3, 1998 entitled “Subscriber Characterization System” (Atty. Docket No. T702-00);

U.S. application Ser. No. 09/205,653, filed on Dec. 3, 1998 entitled “Client-Server Based Subscriber Characterization System” (Atty. Docket No. T703-00);

U.S. patent application Ser. No. 09/516,983, filed on Mar. 1, 2000 entitled “Subscriber Characterization with Filters” (Atty. Docket No. T702-02);

U.S. patent application Ser. No. 09/782,962, filed on Feb. 14, 2001 entitled “Location Based Profiling” (Atty. Docket No. L100-10);

U.S. patent application Ser. No. 09/796,339, filed on Feb. 28, 2001 entitled “Privacy-Protected Targeting System” (Atty. Docket No. T735-00);

U.S. patent application Ser. No. 09/635,252, filed on Aug. 9, 2000 entitled “Subscriber Characterization Based on Electronic Program Guide Data” (Atty. Docket No. T702-02);

U.S. Provisional Application No. 60/260,946, filed on Jan. 11, 2001 entitled “Viewer Profiling Within a Set-Top Box” (Atty. Docket No. T734-00);

U.S. Provisional Application No. 60/263,095, filed on Jan. 19, 2001 entitled “Session Based Profiling in a Television Viewing Environment” (Atty.

Docket No. T735-00); and

U.S. Provisional Application No. 60/278,612, filed on Apr. 26, 2001 entitled “Formation and utilization of cable microzones” (Atty. Docket No. T737-00).

### BACKGROUND OF THE INVENTION

Advertising forms an important part of broadcast programming including broadcast video (television), radio and printed media. Revenues generated from advertisers subsidize and in some cases pay entirely for programming received by subscribers. For example, over the air broadcast programming, such as broadcast television (non-cable) and broadcast radio, is essentially paid for by advertisements (ads) placed in the programming and is thus provided entirely free to the subscribers. The cost of delivering non-broadcast programming, such as cable television, satellite-based television, or printed media (such as newspapers and magazines), is subsidized by advertising revenues. Were it not for the advertising revenues, the subscription rates would be many times higher than at present.

Ads are normally placed in programming based on a linked sponsorship model. The linked sponsorship model inserts ads into programming based on the contents of the programming or the target market of the programming. For example, a baby stroller ad may be inserted into a parenting program. Advertising, and in particular television advertising, is mostly ineffective in the linked sponsorship model. That is, large percentages, if not the majority of ads, do not have a high probability of affecting a sale. In addition, many ads are not even seen/heard by the subscriber who may mute the sound, change channels, or simply leave the room during a commercial break. The reasons for such ineffectiveness are due to the fact that the displayed ads are not targeted to the subscribers' needs, likes or preferences. Generally, the same ads are displayed to all the subscribers irrespective of the needs and preferences of the subscribers.

One way to increase the effectiveness of the ads is to deliver ads that are relevant (targeted) to the subscribers. In order to deliver targeted ads, traits, characteristics and interests of the subscribers need to be identified (i.e., subscriber profile). Numerous methods have been proposed for gathering and processing data about subscribers based on their viewing, purchasing and surfing (Internet) transactions.

However, these methods simply collect and aggregate transaction data or obtain preference/interest data from the subscribers (questionnaires). While these profiles provide details with which to target ads, they lack a comprehensive profile that can be used to target ads. That is, these profiles simply help enhance a linked sponsorship model and do not lead to a targeted model. That is, these profiles provide preferences of a subscriber and may be extrapolated to include similar preferences. Thus, there is a need for a method and system capable of generating a comprehensive profile that is capable of identifying a plurality of characteristics and traits about subscribers that could be used to target ads based on numerous criteria that may be established by the advertisers. With a comprehensive profile the advertiser is provided with a multitude of possible scenarios to target ads and is not limited to an aggregation of subscriber transactions or interests which were defined by the subscriber

In order to target ads, the system must also be capable of correlating ad profiles identifying an intended target market of the ad with the subscriber profiles. Numerous methods have been proposed for correlating ads and subscribers.

However, as discussed above the subscriber profiles are relatively simplistic so the correlation of the ads and subscribers is limited to attributes that may be defined in the subscriber profiles. Moreover, there is no disclosure of correlating ads with a complex profile or correlating ads with data about the subscriber that is contained in a plurality of distributed databases. Thus, there is a need for a system and method that is capable of correlating ads with subscribers based on a plurality of criteria and also a need for a system and method for correlating ads with subscriber data that may be distributed over a plurality of locations.

It may be impractical to target ads to each subscriber. For this reason there is also a need for a method and system for grouping subscribers together based on various criteria. The grouping of subscribers should not be limited to geographic proximity. The grouping should be capable of being based on the ad profiles or the subscriber profiles. The groups should be capable of aggregating nodes into microzones within a cable TV system together so that ads can be targeted to the microzones. Targeting ads at the microzones level would allow the targeting of ads within the current architecture of the cable TV plant.

### SUMMARY OF THE INVENTION

The present invention is directed at a system, method and apparatus for targeting advertisements (ads) to subscribers. The ads are targeted to subscribers by correlating subscriber profiles with ad profiles. The subscriber profiles identify characteristics and/or traits associated with the subscriber and the ad profiles identify characteristics and/or traits about an intended target market for the ad. Targeting ads proves to be beneficial to subscribers, advertisers, and content providers. The subscribers receive ads that are more likely applicable to their life style. Content providers can charge advertisers a premium for delivering targeted ads. Advertisers save money because they only pay to deliver the ads to subscribers that most likely are interested in the ad.

The subscriber profiles are generated by a Secure Profiling Server (SPS). The characteristics and/or traits associated with the subscriber profile can be retrieved from a plurality of sources. The profile may include data from a subset or all of the multiple sources and may be simple or complex in form. The plurality of sources may include distributed or centralized databases that include viewing characteristics, purchasing characteristics, transaction characteristics, statistical information and deterministic information. The plurality of sources may be public and/or private databases. In one embodiment, the viewing characteristics data is generated within the current system by monitoring subscriber interaction with the television and aggregating the data to form the viewing characteristics. The subscriber interaction includes at least some subset of channel changes, volume changes, EPG activation and record commands. The viewing characteristics include at least some subset of program preference, network preference, genre preference, volume preference, dwell time, and channel change frequency.

The statistical information may be collected from a variety of sources including private and public databases. For example, MicroVision, a product of Claritas, Inc. of San Diego, Calif. provides demographic segment statistical information for market segments defined by ZIP+4 (approx. 10-15 households). The statistical information may also be generated by applying heuristic rules to the subscriber characteristics. For example, heuristic rules can be applied to the viewing characteristics to generate a probabilistic demographic make-up of the subscribers. The deterministic information can be obtained by having the subscriber answer a questionnaire or survey. The deterministic information may include at least some subset of demographics and interests.

In accordance with the principles of Quantum Advertising™, the subscriber profile may be contained in a vector, such as a ket vector |A>, where A represents the vector describing an aspect of the subscriber. The ket vector |A> can be described as the sum of components such that

$$\vert A >= ( {a}_{1} {ρ}_{1} + {a}_{2} {ρ}_{2} + … {a}_{n} {ρ}_{n} ) + ( {b}_{1} {σ}_{1} + {b}_{2} {σ}_{2} + … {b}_{n} {σ}_{n} ) + … + ( {e}_{1} {ω}_{1} + {e}_{2} {ω}_{2} + … {e}_{n} {ω}_{n} )$$

wherein a₁ through eₙ represent probability factors and ρ₁ through ωₙ represent characteristics selected from at least a subset of viewing characteristics, purchase characteristics, transaction characteristics, demographic characteristics, socio-economic characteristics, housing characteristics, and consumption characteristics. The SPS may also form groups of subscribers having similar profiles. The groups may be formed based on cable television (CTV) system elements such as head-end, node or branch.

Ad profiles and subscriber profiles are received by a Secure Correlation Server™ (SCS). The SCS correlates the ad profiles with one or more subscriber profiles or one or more group of subscribers. The correlation can be performed by applying an operator to the subscriber profiles in the form of ket vectors to determine if a particular ad is applicable to the subscriber.

The targeted ads can be inserted into program streams using an Ad Insertion System (AIS). The AIS creates at least one presentation stream that is a program stream with an inserted targeted advertisement. In a preferred embodiment, the ad insertion is performed at the head-end. A single presentation stream may be sent to the appropriate subscribers or multiple presentation streams may be sent and the appropriate presentation stream is selected by the node, the branch or the subscriber (via a STB or PVR). Alternatively, the ad insertion may be done by the node or by the subscriber (via a PVR). If the ad insertion is done by the PVR, the targeted ads are delivered to the PVR separate from the program streams and inserted in the program stream at the PVR. The ads are inserted in accordance with a queue. Alternatively, advertisements along with ad profiles are delivered to the PVR and the PVR correlate the ad profiles with a subscriber profile to determine which ads are applicable (are targeted ads).

The general principles of the present invention are not constrained to video networks and may be generally applied to a variety of media systems including printed media, radio broadcasting, and store coupons. The method and system provide the overall capability to match ads to subscribers by correlating ad profiles and subscriber profiles, wherein the subscriber profiles do not contain raw transaction data or private information. Thus, targeted advertising can be performed while at the same time maintaining (not violating) subscribers privacy.

### BRIEF DESCRIPTION OF THE DRAWINGS

These and other features and objects of the invention will be more fully understood from the following detailed description of the preferred embodiments that should be read in light of the accompanying drawings:

FIG. 1 illustrates an exemplary television system utilizing a traditional advertising model;

FIG. 2A illustrates an exemplary advertisement applicability model for a traditional advertising model;

FIG. 2B illustrates an exemplary success rate for different applicability groups of the traditional model of FIG. 2A;

FIG. 3A illustrates an exemplary advertisement applicability model for a targeted advertising model in accordance with the principles of the current invention;

FIG. 3B illustrates an exemplary success rate for different applicability groups for each targeted ad in the targeted model of FIG. 3A;

FIG. 4A illustrates an exemplary comparison of the traditional model to the targeted model;

FIG. 4B illustrates exemplary advertisement fees based on success rate;

FIG. 4C illustrates an exemplary comparison of the traditional model to the targeted model;

FIG. 5 illustrates an exemplary television system utilizing the targeted advertising model;

FIG. 6 illustrates an exemplary secure profiling system used in the system of FIG. 5;

FIG. 7 illustrates an exemplary context diagram of a viewing characterization and profiling system (VCPS);

FIGS. 8 and 9 illustrate exemplary program data;

FIGS. 10-12 illustrate exemplary embodiments of subscriber selection data;

FIGS. 13-16 illustrate exemplary embodiments of viewing characteristics;

FIG. 17A illustrates an exemplary demographic profile associated with a ZIP+$ area;

FIG. 17B illustrates an exemplary billing system of a TV system;

FIG. 17C illustrates an exemplary combination of FIGS. 17A and 17B;

FIGS. 18 and 19 illustrate exemplary logical and probabilistic heuristic rules;

FIGS. 20A-C illustrate exemplary day part adjustments;

FIG. 21 illustrates an exemplary probabilistic subscriber demographic profile;

FIGS. 22A-B illustrates an exemplary survey used to obtain deterministic information about a subscriber;

FIG. 23 illustrates an exemplary subscriber profile vector taking into account vectors describing numerous aspects of a subscriber;

FIGS. 24A-B illustrate exemplary probabilities associated with different ket vector traits;

FIGS. 25A-B illustrates an exemplary survey used to generate an ad profile;

FIG. 26 illustrates an exemplary method for correlating clusters to predefined ad profiles;

FIGS. 27 and 28 illustrate exemplary embodiments for correlating subscriber clusters into groups;

FIGS. 29A-C illustrates an exemplary correlation of two profiles;

FIG. 30 illustrates an exemplary cable TV (CTV) system;

FIG. 31 illustrates an exemplary mapping of subscriber to elements of the CTV system;

FIG. 32 illustrates an exemplary head-end for delivering target ads to the subzone;

FIG. 33 illustrates an exemplary spectral allocation;

FIG. 34 illustrates an exemplary head-end for delivering target ads to the microzone;

FIG. 35 illustrates exemplary node clusters;

FIG. 36 illustrates an exemplary system for delivering targeted channel lineups to different node clusters;

FIGS. 37A-C illustrate exemplary embodiments of a node capable of delivering targeted ads to the branch;

FIGS. 38A-C illustrates exemplary spectral allocation for delivering presentation streams at different frequencies and a frequency remapping of the channels;

FIG. 39 illustrates an exemplary spectral allocation for delivering presentation streams at different wavelengths; and

FIG. 40 illustrates an exemplary spectral allocation for delivering ads separate from the program streams.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

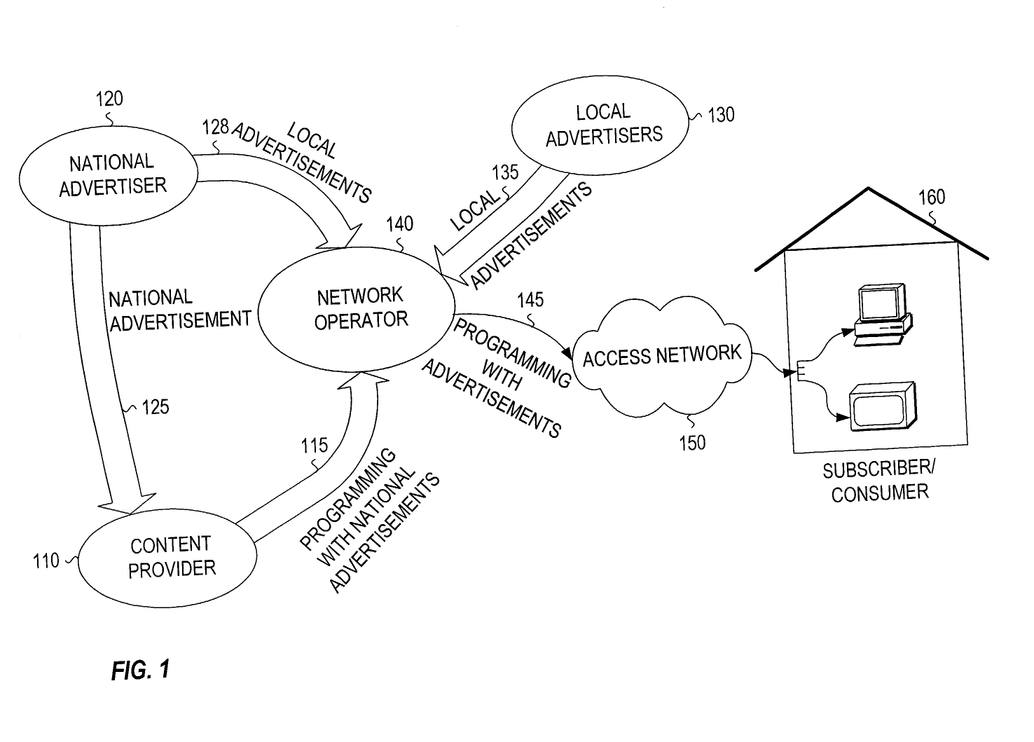

With reference to the drawings, in general, and FIGS. 1 through 40 in particular, the method, apparatus, and system of the present invention are disclosed.

FIG. 1 illustrates a traditional television (TV) system utilizing a traditional advertising business model. The TV system consists of a content provider 110, national advertisers 120, local advertisers 130, a network operator 140, an access network 150, and subscribers 160. The content provider 110 produces syndicated programs having advertising opportunities (avails) therewithin. The national advertisers 120 provide national advertisements (ads) 125 to the content provider 110. The content provider 110 multiplexes the national ads in the syndicated programming to generate a program stream (programming with ads) 115 that is transmitted to the network operator 140. Generally, the network operator 140 purchases the programming contents for a fee and is provided with a right to substitute a percentage of the national ads 125 with local ads (e.g., 20% substitution). Thus, the network operator 140 may directly receive local ads 128 from the national advertisers 120 or local ads 135 from the local advertisers 130 and replace a percentage of the national ads 125 with these local ads 128, 135. The network operator 140 transmits the program stream (with approximately 20% of the national ads 125 replaced with local ads 128, 135) 145 to the subscribers 160 via the access network 150. The access network 150 may be a cable TV (CTV) network, a Switched Digital Video (SDV) network or other networks now known or later discovered and may have a hybrid fiber-coax (BFC) architecture, a satellite-based architecture, an Internet-based architecture, digital subscriber line (xDSL) architecture, fiber to the curb (FTTC) or fiber to the home (FTTH), or other architectures now known or later discovered. Such access systems are well known to those skilled in the art. The program stream 145 may be delivered to a personal computer, a TV or any other display means available at the subscriber end.

In traditional TV systems, such as those illustrated in FIG. 1, the local ads are not generally customized based on the needs/preferences of the subscribers 160. Instead, the same ad is displayed to all subscribers 160 within a particular location (i.e., all subscribers serviced by a head-end). Thus, for example all the subscribers 160 will receive an ad for the opening of a new BMW dealership, even if a majority of the subscribers 160 could not afford such a car. Thus, even though the traditional advertising scheme as illustrated in FIG. 1 attempts to substitute some local ads for the national/generic ads, the effectiveness of the ads is not likely to be greatly increased as the ads are not customized/tailored based on subscriber preferences/likes.

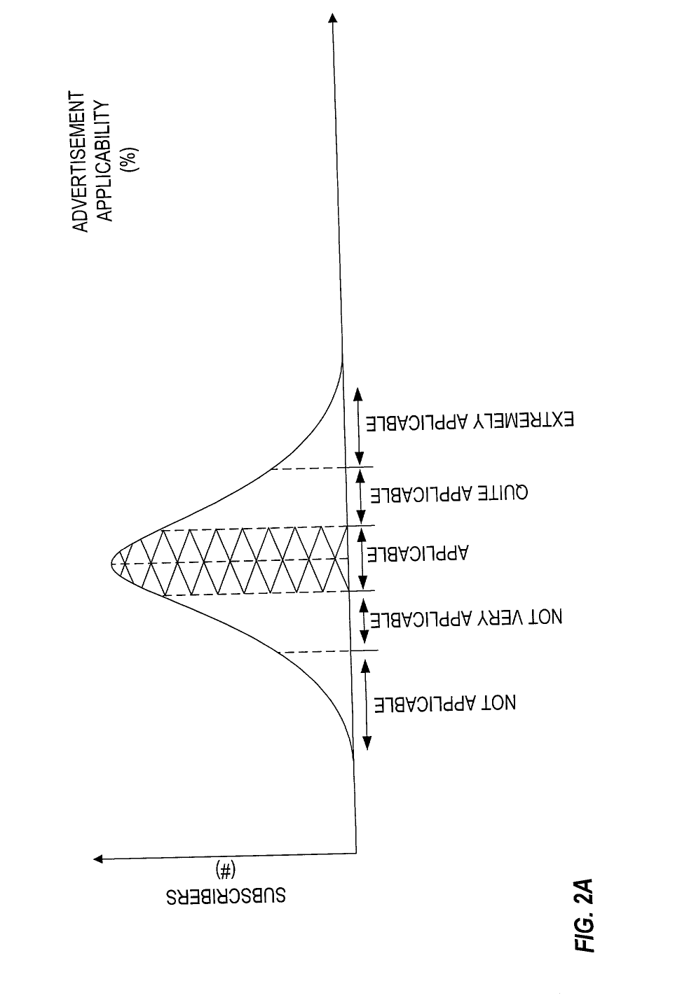

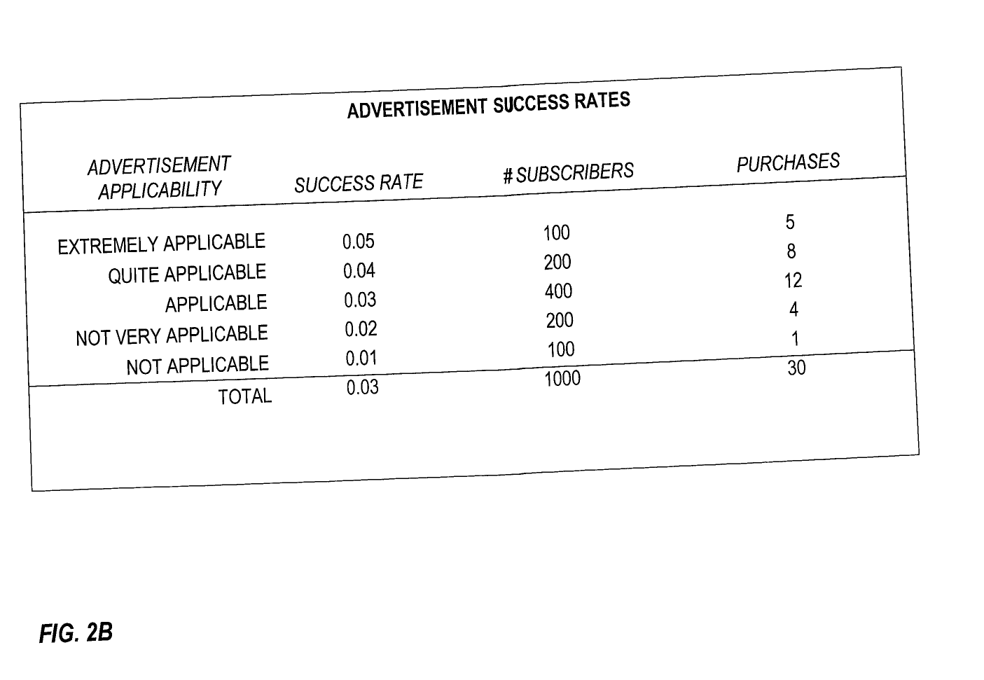

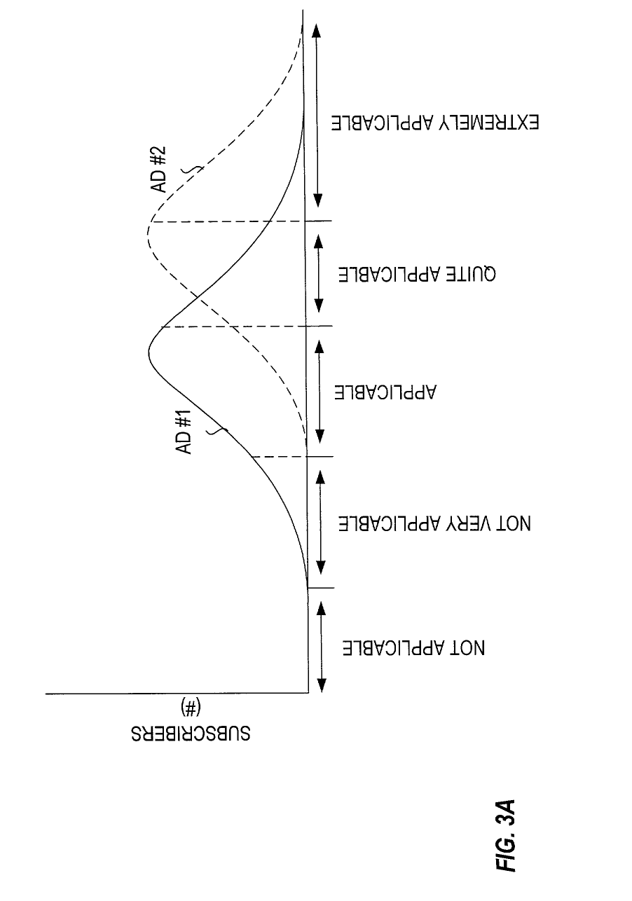

FIG. 2A illustrates ad applicability modeled as an exemplary distribution (i.e., bell) curve. As illustrated in FIG. 2A, a well-designed ad should be “applicable” to a majority of subscribers. However, the ad most likely will have an applicability distribution such that the ad will be “quite applicable” or even “extremely applicable” to some subscribers and “not very applicable” or even “not applicable” to other subscribers. As would be obvious to one of ordinary skill in the art, the distribution (i.e., shape, amplitude, positioning) of the curve will vary depending on the ad.

The probability of a subscriber purchasing a product or service after viewing the associated ad is defined as a success rate. The success rate can be determined by measuring products or services that were purchased as a result of the viewing of an ad. The success rate may be measured for each applicability grouping (i.e., “not”) or the overall success rate may be determined and distributed amongst the groupings. It would be expected that the subscribers that find the ad to be “extremely applicable” are most likely to purchase the product or service, and the subscribers that find the ad to be “not applicable” are least likely to purchase the product or service.

FIG. 2B illustrates an exemplary correlation between ad applicability and success rate. As illustrated, the highest success rate corresponds to the subgroup that finds the ad to be “extremely applicable”, and the lowest success rate corresponds to the subgroup that finds the ad to be “not applicable”. FIG. 2B also illustrates the number of subscribers associated with each applicability subgroup. The number of expected purchases for each group as well as the total number of purchases is then calculated. For example, as illustrated the “extremely applicable” group has a 5% success rate defined and 100 subscribers within the group, so that a projected 5 subscribers will purchase the product/service advertised. An overall success rate for the entire 1000 subscribers is calculated as 3% (a total of 30 subscribers actually make or are predicted to make a purchase).

As one skilled in the art would recognize, the more applicable the ads are to the subscribers, the higher the success rate. In accordance with the principles of the current invention, the subscribers are divided into subgroups, and different ads are targeted to each subgroup. That is, the targeted ads are sent to only those subgroups that are most interested in the ad, and thus most likely to purchase the product. By forming subgroups and targeting ads to one or more subgroups, the effectiveness of the ads may be greatly increased, and overall ad success rates may be greatly increased. The increase in overall ad success rates represents more effective use of advertising dollars, and is a “welfare gain” in the sense that those dollars may be used for other goods and services.

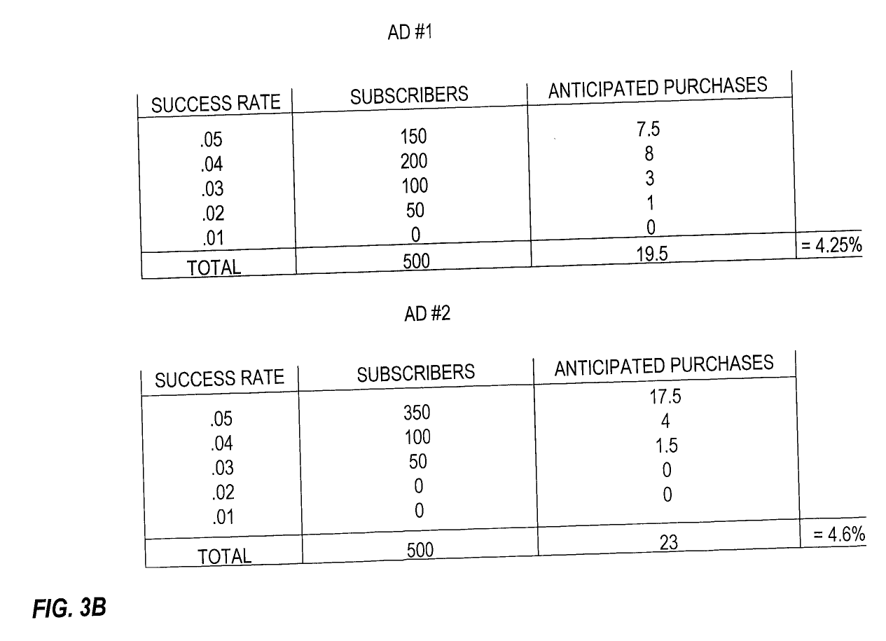

FIG. 3A illustrates an exemplary case where subscribers are divided into subgroups, and the ads are displayed to the subgroup the ad is most applicable to. As illustrated the distribution curve for each ad is shifted upwards (to the right) on the applicability axis. The first ad has been shifted to the right so that none of the subscribers fall in the “not applicable” category and most of the subscribers fall in the “quit applicable” category. The second ad has been shifted even further to the right so that none of the subscribers fall in either the “not applicable” or “not very applicable” categories and a majority of the subscribers fall in the “extremely applicable” category. FIG. 3B illustrates an exemplary success rate for each of the ads and an overall success rate for the 1000 subscribers. As illustrated, each of the ads was delivered to 500 subscribers (half of the original sample). The chart predicts that the first ad will result in 19.5 purchases (a g 3.9% success rate) and the second ad will result in 23 purchases (a 4.6% success rate). The overall purchases predicted to be made in response to the two ads for the 1000 subscribers is 42.5 (a 4.25% success rate).

In the example of FIGS. 3A and 3B, the subscriber population was only split in half and only two targeted ads were delivered thereto. If the population was further divided and additional targeted ads were delivered thereto, the success rate would increase further. This type of grouping should benefit both advertisers and establishments (i.e., network operators) that deliver the ads. Advertisers normally pay a fee per subscriber that is anticipated to receive the ad (i.e., estimated subscribers that will watch the program the ad will be inserted in). As would be obvious to one of skill in the art, the fee per applicable subscriber (subscriber that the ad is at least applicable to) increases as the number of applicable subscribers decreases. For example, an advertiser may pay $2 million ($0.25 per subscriber to reach the anticipated 8 million subscribers) of Monday Night Football (MNF). If all 8 million subscribers are applicable, then the advertiser is paying an effective rate of $0.25/applicable subscriber. However, if the number of applicable subscribers was anticipated to be 4 million (50% of the anticipated number of total subscribers), then the advertiser is paying an effective rate of $0.50/applicable subscriber.

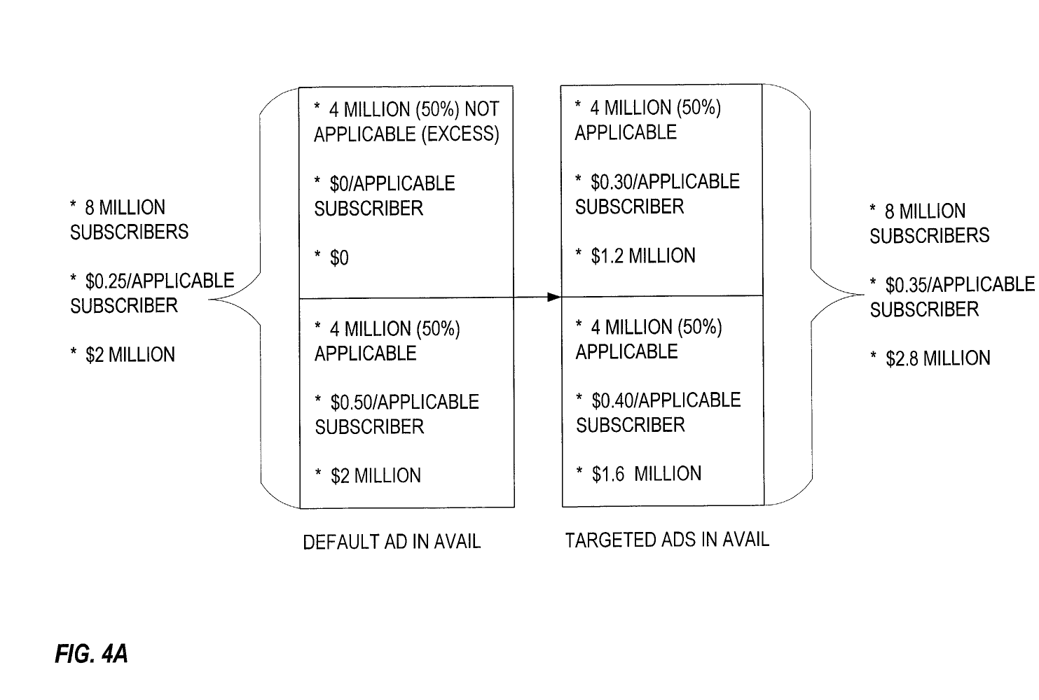

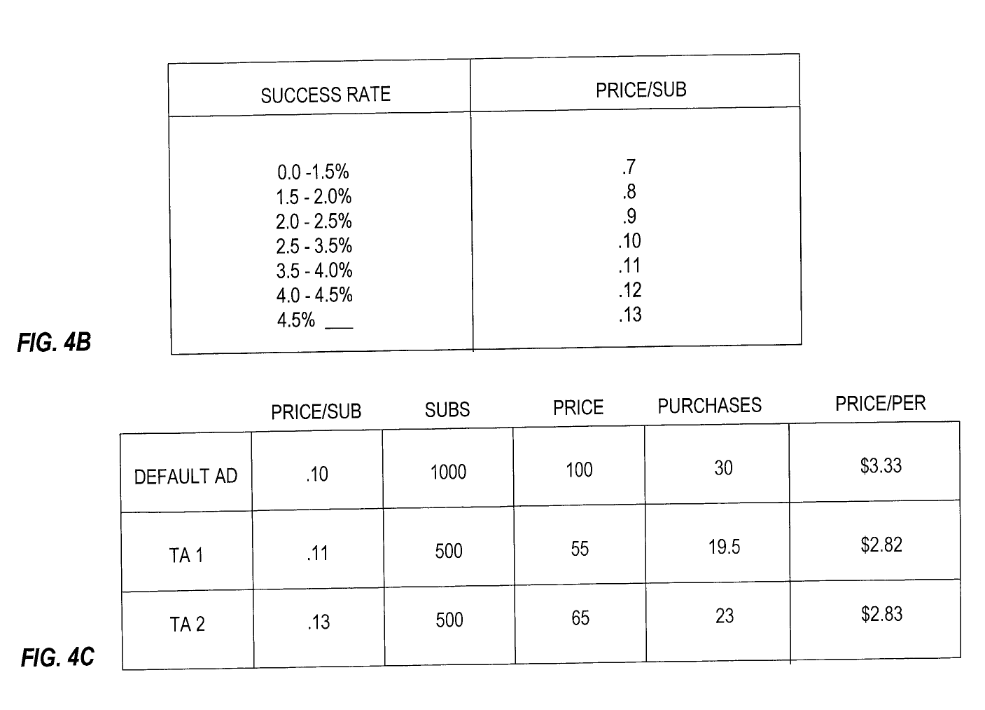

According to the principles of the current invention, the ad discussed above should only be targeted to the applicable subscribers (50%). Different targeted ads should be directed to the other 50%. FIG. 4A illustrates an exemplary graphical representation of the ad avail with a default ad compared to the ad avail with two targeted ads. For the default ad the subscriber pays $0.25/sub ($2 million) to reach the 8 million subs. Since the target market for this default ad is only 50% (4 million subs) the advertiser is in effect paying $0.50/sub for the applicable subscribers and getting the excess for free. In accordance with the principles of the present invention, the excess subscribers do not receive the default ad and instead receive a targeted ad. The advertisers of the targeted ads pay a per subscriber fee that is higher than the per subscriber fee for all subscribers but that is less than the effective per subscriber fee for the applicable subscribers. As illustrated, the first advertiser pays $0.40/sub ($1.6 million) and the second subscriber pays $0.30/sub ($1.2 million). Thus, each of the advertisers save money by not paying for excess and the network operator makes additional money by charging a premium for the ads being targeted. The difference between the $0.30/sub and $0.40/sub may be based on the applicability of the ads to the targeted group of subscribers. As previously discussed, the more applicable an ad is to a subscriber, the more the anticipated success rate is.

FIG. 4B illustrates an exemplary fee schedule based on anticipated success rate of the targeted advertisement. It should be noted that as discussed above, predicted success rate is based on ad applicability. Moreover, it should be noted that the success rate may vary for different products or services. For example, an ad that is “not very” applicable may have a success rate of 10% for a first product, while an ad that is “extremely” applicable may only have a 5% success rate for a second product. As illustrated, the fee increases as the success rate increases. The standard fee is illustrated as 0.10/subscriber if the success rate falls in the range on 2.5% to 3.5%. It is assumed that this is the range of success for linked sponsorship, where the ads placed in programs having a target audience similar to the target market of the ad (FIG. 2A is an example of a linked sponsorship ad). The fee increases or decreases by 0.01/subscriber for each 0.5% increase or decrease in success rate respectively.

FIG. 4C illustrates a comparison of the price an advertiser would pay per predicted successful purchase for the default ad of FIG. 2A and the targets ads of FIG. 3A. As illustrated the price/purchase for the default ad is $3.33 while the price for first and the second targeted ads is $2.82 and $2.83 respectively. Thus, the advertisers benefit by targeting their ads. Moreover, the operator benefits because they now can charge a higher rate (on a per subscriber basis) and in the aggregate receive more money. In this example, the operator would receive $120 ($55+$65) for delivering the two ad to the same 1000 subscribers as the default ad which netted the operator $100. As should be obvious to one of ordinary skill in the art, these figures are simply for exemplary purposes and in no way are intended to limit the scope of the current invention.

As should be obvious to one of ordinary skill in the art, there are numerous characteristics by which subscribers can be grouped, including but not limited to geographic, demographic, psychological, psychographic, socio-cultural, viewing habits, purchase habits, Internet surfing habits, interests and hobbies. The groups may be formed on a single characteristic or may be grouped on some combination of characteristics. These characteristics can be gathered from a multitude of different sources, may be generated within, or a combination thereof. If the characteristics are obtained from outside sources, the data may be in a form that can be used to generate subgroups or may require processing. If subgroups are to be based on multiple characteristics, the characteristics may be combined within the system of the current invention or done externally by a third party.

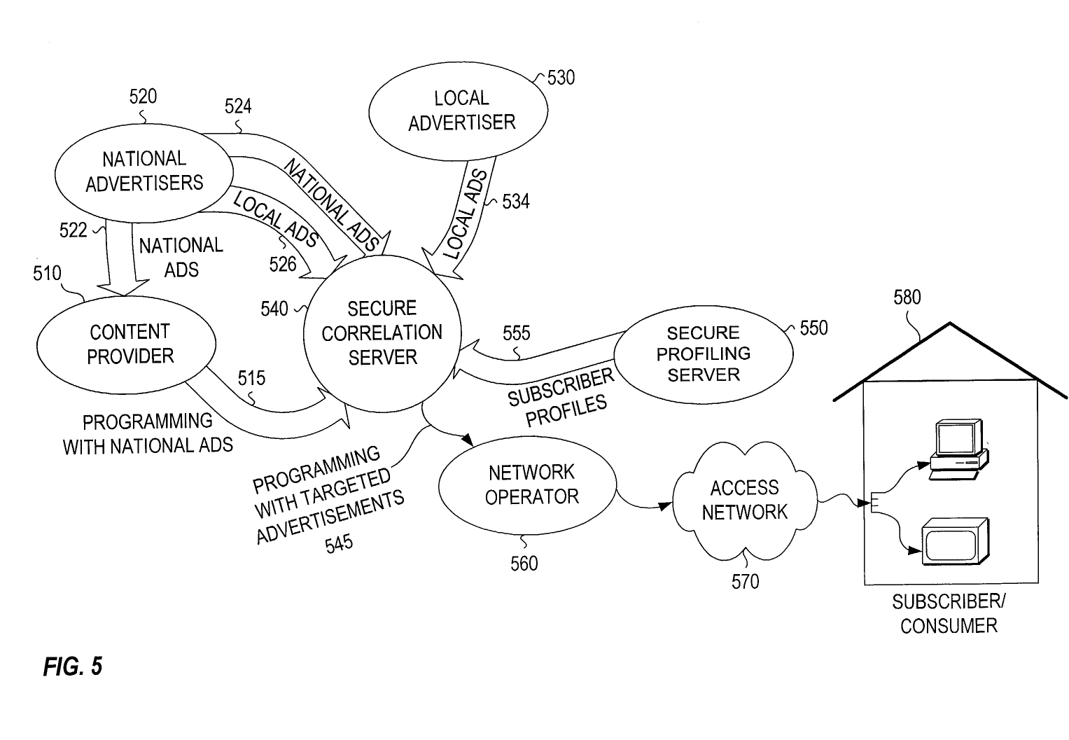

FIG. 5 illustrates an exemplary system for grouping TV subscribers into subgroups and delivering targeted ads thereto based on the principles of the present invention. The exemplary system includes content providers 510, national advertisers 520, local advertisers 530, a Secure Correlation Server™ (SCS) 540, a Secure Profiling System (SPS) 550, a network operator, an access network and subscribers 580. As with the typical model, the national advertiser 520 delivers national ads 522 to the content providers 510 and the content providers 510 generate and deliver program streams (programming with national ads inserted therein) 515. However, the program stream 515 is not delivered directly to the network operator 560 as with the standard system of FIG. 1. Instead, the program stream is delivered to the SCS 540. The SCS 540 also receives additional national ads 524 and local ads 526 from the national advertiser 520, and local ads 535 from the local advertisers 530. The SCS 540 also receives subscriber profiles 555 from the SPS 550. The SCS 540 is configured to correlate ads with subscribers, so that ad effectiveness is increased. The SCS determines which ads (additional national ads 524, local ads 526, 535) should be substituted (targeted) for the ad (default ad) within the program stream 515 and which subscribers 580 should receive which ads.

In one embodiment, the SCS 540 creates presentation streams 545 that have the same programming but targeted ads in place of the default ad. The presentation streams 545 are delivered to the network operator 560. The network operator 560 delivers the presentation streams 545 to the subscribers 580 via the access network 570. The presentation streams 545 may be delivered to the subscribers 580 on a personal computer, a TV or any other display means. As previously described the access network may be CTV, SDV, satellite, or other type of networks now known or later discovered, having an HFC, a satellite-based, an Internet-based, an xDSL, a FTTC, a FTTH, or other now known or later discovered architectures. The network operator 560 may deliver each presentation stream 545 to each subscriber 580 and an indication of which ad is designated for which subscriber 580 or may deliver only the appropriate presentation stream 545 to each subscriber 580 (discussed in more detail later).

The SCS 540 may create subgroups based on input from the SPS 550 and then match ads to those groups, or may receive ads having specific criteria and form groups based on the specific desires of the advertisers. In either event, the SPS 550 generates profiles of the 15 subscribers 580 that are used to form groups and thus correlate ads. The profiles generated by the SPS 550 may be simple or complex, may be generated from a single source of data or be a compilation of multiple sources of data, and may be probabilistic or deterministic in nature. No matter what the form of the subscriber profile, it is done in a way to protect the privacy of the subscriber. That is, the subscriber's identity is not known or given out, and raw transaction data is not available for distribution and is discarded after it is processed or at standard intervals, such as every night.

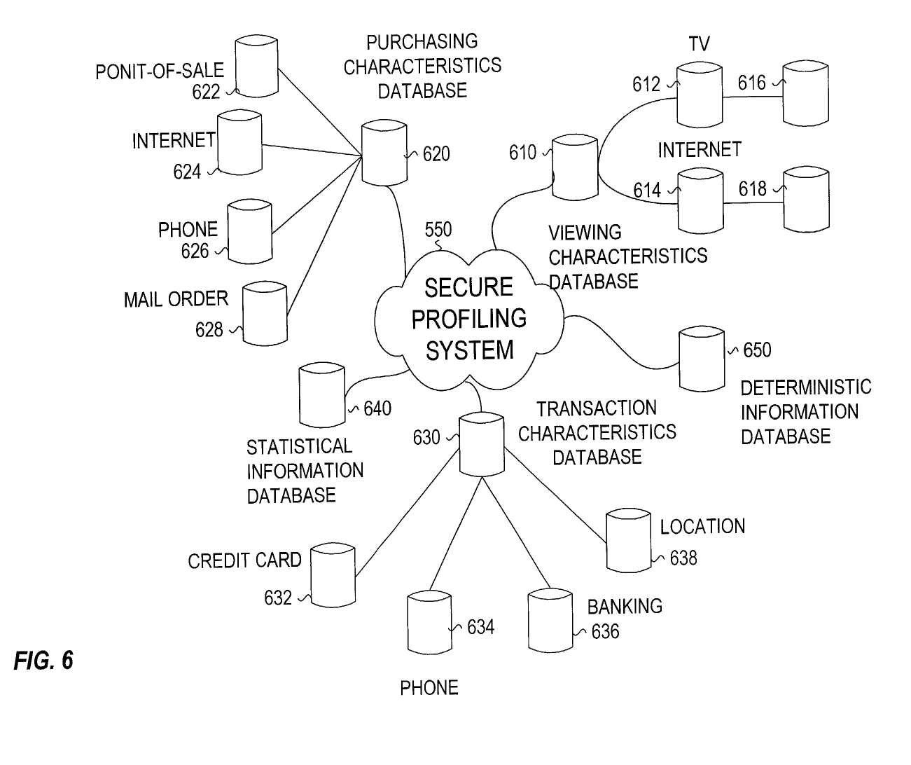

FIG. 6 illustrates an exemplary SPS 550 receiving data from a variety of sources including but not limited to a viewing characteristics database 610, a purchasing characteristics database 620, a transaction characteristics database 630, a statistical information database 640, and a deterministic information database 650. It will be apparent to one skilled in the art, that there are numerous sources for this data and that the data may be gathered from a single source or be an aggregate of numerous sources. Moreover, data from one source may be analyzed by the SPS 550 and the analysis stored in another database. As should be obvious to one of ordinary skill in the art, the SPS 550 could generate various different profiles taking into account different data. According to one embodiment, the profiles are formed in advance and forwarded to the SCS 540 where they are matched with ads. According to another embodiment, the SPS 550 receives ad characteristics from advertisers via the SCS 540 and based on the available data generates associated profiles that it forwards to the SCS 540 for matching.

The SPS 550 is designed with protecting the privacy of subscribers in mind. In one embodiment, the subscribers would have to select “opt-in” to be profiled by the system. In return for selecting to be profiled, the subscriber would receive ads that were targeted for their particular interests. Most likely additional incentives would have to be offered such as reduced fees products or services (i.e., cable bill). In another embodiment, raw transaction data would not be made available or possibly not stored, but instead characteristics about the transactions would be stored. In another embodiment, the identity of the subscriber is kept confidential and is never provider to outside parties (such as advertisers). Rather, the outside parties may be provided with a grouping of subscribers having characteristics that match the characteristics that the advertiser is seeking. In another embodiment, the SPS 550 will not generate groups of subscribers that have characteristics that would be confidential (i.e., subscribers who have AIDS). In another embodiment, the SPS 550 is managed by a trusted third party, such as a non-profit organization, that ensures that the privacy of subscribers is not violated. This trusted third party would maintain the data in a manner that ensured consumers their privacy was not violated and may provide government, consumer advocacy, or industry representatives audit rights.

As illustrated, the viewing characteristics database 610 may receive data from a TV viewing characteristics database 612 and an Internet viewing characteristics database 614. Each of these databases may receive transaction data from a TV transaction database 616 and an Internet transaction database 618 respectively. As one of ordinary skill in the art would recognize, the definition between TV and Internet transactions is not clearly defined as we move towards interactive TV and streaming media on computers. Moreover, TV transactions are not limited to broadcast and cable television but may include pay per view (PPV), video on demand (VOD), near VOD (NVOD), or other video that may be delivered over a television access network. Furthermore, Internet transactions are not restricted to computers as one can connect to the Internet with wireless phones, personal digital assistance, and other devices now known to those skilled in the art or later discovered. As one skilled in the art would recognize, the viewing characteristics are not limited to TV and Internet transactions but could include other viewing transactions that would be known to one of ordinary skill in the art. According to a preferred embodiment for a TV system such as that illustrated in FIG. 5, the current invention will monitor subscriber interactions, such as viewing activities, and generate subscriber characteristics from the monitored data.

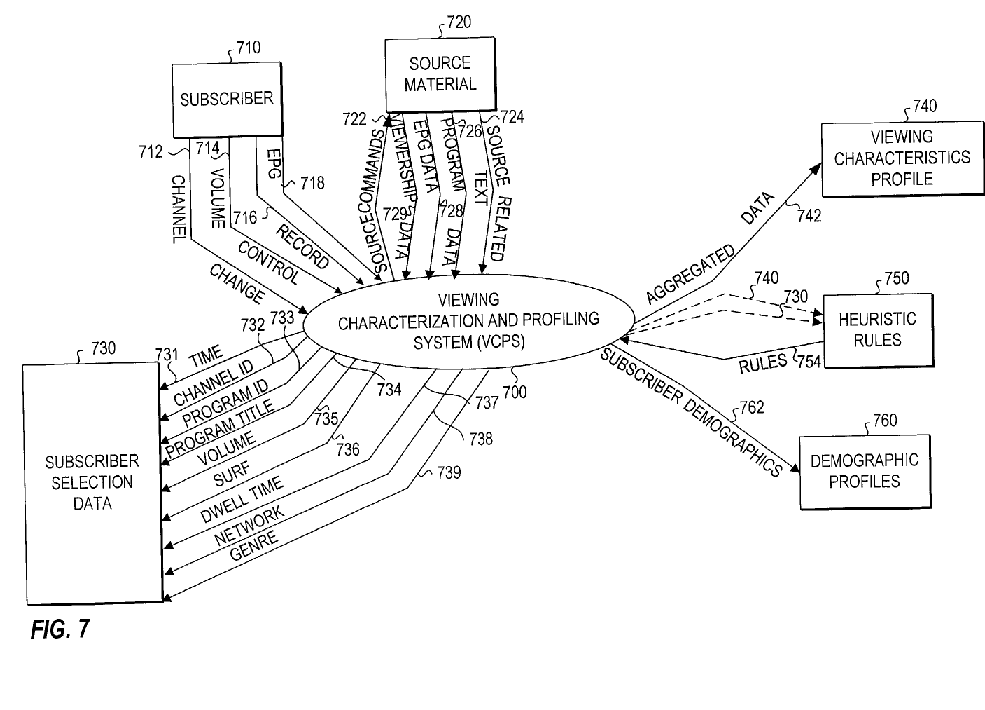

FIG. 7 depicts a context diagram of an exemplary embodiment of a viewing characterization and profiling system (VCPS) 700 used to collect viewing activity data and generate viewing characteristics profiles therefrom. This data may be collected by the network operator 560, by individual subscribers 580, or be distributed amongst some combination of these. In a SDV system it is likely that the network operator 560 would collect the data while in a CTV system it is more likely that each individual subscriber 580 collects the data. If the subscriber 580 collects the data it is likely that the data is collected in a set-top box (STB), personal video recorder (PVR), or some now known or later developed equipment (hereinafter simply referred to as STB). Whether collected by the network operator 560 or the subscriber 580 via the STB, the system could capture all transaction data for each subscriber. However, for privacy reasons, the system is designed so raw transaction data is not maintained but is aggregated, summarized or characterized in some fashion. That is, the system will maintain statistics such as most likely watched programs and networks as opposed to every channel change, volume adjustment, etc. Moreover, each subscriber will not be identified by personal information, such as name, but instead will be identified by some unique identification, which may include but it not limited to customer number, media access control (MAC) ID, and Internet protocol (IP) address.

In generating one or more viewing characteristics vectors, the VCPS 700 receives input from the subscriber 710 in the form of commands from a subscriber interface device, such as a remote control. The commands include but are not limited to channel changes (channel selection) 712, volume changes 714, initiation of recording 716 (such as on a video cassette recorder or PVR), and interaction with an electronic or interactive program guide (EPG) 718 (i.e., activation, use, customization of). If the VCPS 700 was monitoring viewer interaction with a computer, interactive TV or other device connected to the Internet, the subscriber interactions may also include sites visited, click throughs, book marks and other commands applicable to Internet surfing that would be obvious to one of ordinary skill in the art. Source commands 722, such as channel selections 712, recording initiation 716, or EPG interaction 718, will provide the subscriber with source material 720, such as TV programs, ads, EPGs, web pages or other data. The source material 720 may be in a form including but not limited to analog video, digital video (i.e., Motion Picture Expert Group (MPEG)), Hypertext Markup Language (HTML) or other types of multimedia source material.

Information related to the source material 720, such as source related text 724, program data 726, EPG data 728, or viewership data 729 can be retrieved and analyzed by the VCPS 700. The source related text 724 could be either the entire text associated with the source material 720 or a portion thereof. The source related text 724 can be derived from a number of sources including but not limited to closed captioning information (embedded in the analog or digital video signal), EPG material, and text within the source material 720 (e.g., text in HTML files). The source related text 724 associated with TV programming might be searched to extract such information as program title, actors, key words, program type (i.e., comedy, drama), network, time, and other data that would be obvious to one of ordinary skill in the art. The source related text 724 associated with surfing on the Internet, might be searched to extract information such as the type (i.e., kid, adult) and purpose (i.e., educational, sales) of sites visited.

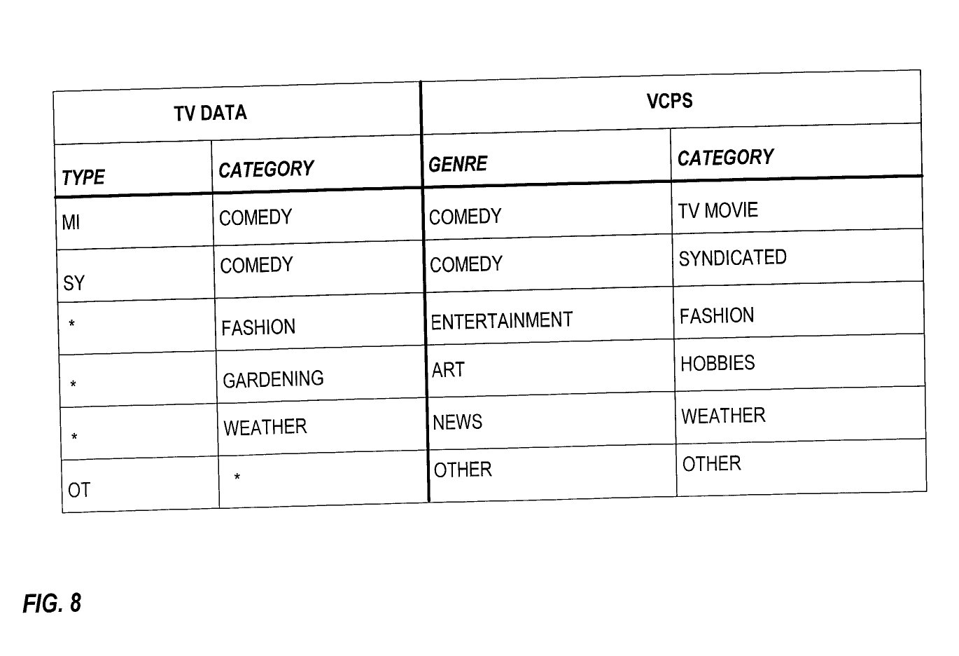

The program data 726 in the context of the present invention is meant to include and encompass one or more subsets of information, which identifies, describes and generally characterizes specific TV programs and TV networks, categories of programs and networks, etc. The program data 726 can be readily obtained from several commercial enterprises including TV Data of Glen Falls, N.Y. or may be obtained from an EPG that identifies programs by categories, sub-categories and program descriptions. The program data 726 from TV Data classifies each program by type and category as illustrated in FIG. 8. For example, the type may include movie (MI), syndicated (SY), other (OT) or all (*) and the categories may include comedy, fashion, gardening and weather.

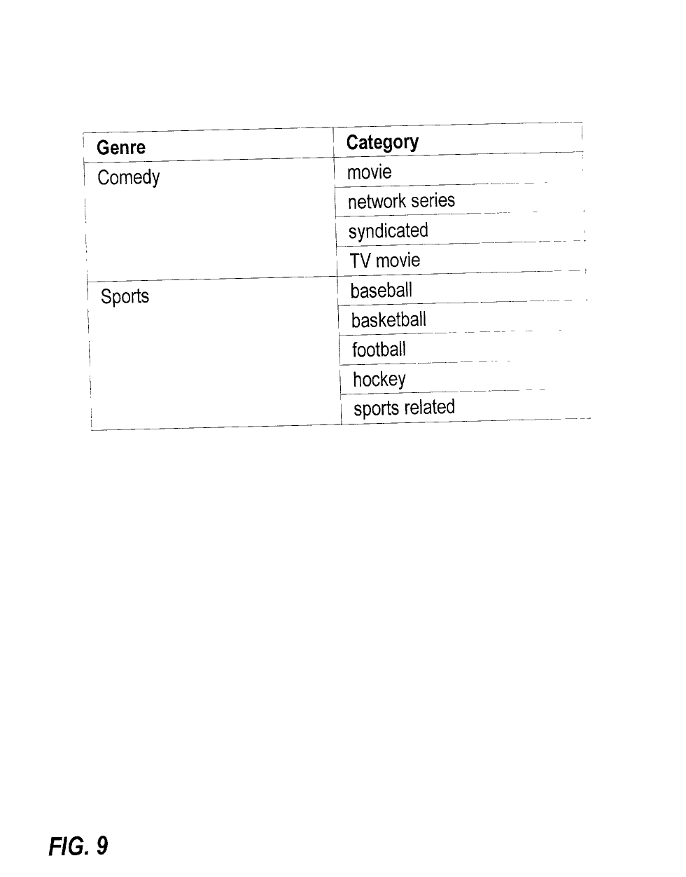

The VCPS 700 may use the program data 726, such as TV Data, as it is received or it may modify the data accordingly. For example, the VCPS 700 may convert the TV Data to genre and category, where the genre is a consistent high-level classification of a program (i.e., a generic set of program types or categories), such as sports, comedy, and drama and the category is a sub-class of the genre classification that is a more specific classification than the genre. FIG. 8 also illustrates and exemplary mapping of TV Data type and category to program genre and program type. For example, a TV Data program type “SY” (syndicated) and category “comedy” maps to a VCPS genre “comedy” and type “syndicated”. FIG. 9 illustrates an exemplary subset of genres and categories as defined by the VCPS 700. As illustrated, a comedy genre includes categories for movie, network series, syndicated, and TV movie. As one of ordinary skill in the art would recognize, the number and type of genres, the number and type of categories, and the relationship therebetween can be modified without departing from the scope of the current invention.

The EPG data 728 may include the format and/or content of the EPG as customized by the subscriber. For example, upon activation one subscriber 710 may customize the EPG to display all sports for the next 2 hours while another subscriber may customize the EPG to display all the shows on ABC, NBC and CBS followed by all News shows for the next hour.

The viewership data 729 may include data related to the number and type of viewers that typically watch certain programs. The viewership data 729 may be based on sampling subscribers to determine programs they watch and other characteristics or demographics about them. This data can be obtained from numerous sources, including Nielsen ratings. In an SDV environment, the viewership data 729 can be generated by the network operator as channel changes are received by the head-end and only the desired channels are delivered to the subscriber. The viewership data 729 can be used to compare the subscribers viewing patterns with industry wide viewing patterns.

The VCPS 700 may store all or a portion of the commands received from the subscriber (712-718) and all or a portion of the data associated with the source material (724-729) as subscriber selection data 730. The subscriber selection data 730 may include but is not limited to time 731, channel ID 732, program ID 733, program title 734, volume 735, channel change sequence (surf) 736, dwell time 737, network 738, and genre 739. The subscriber selection data 730 can be stored in a dedicated memory or in a storage disk. In a preferred embodiment, once the data is characterized (discussed later) the raw transaction data is discarded.

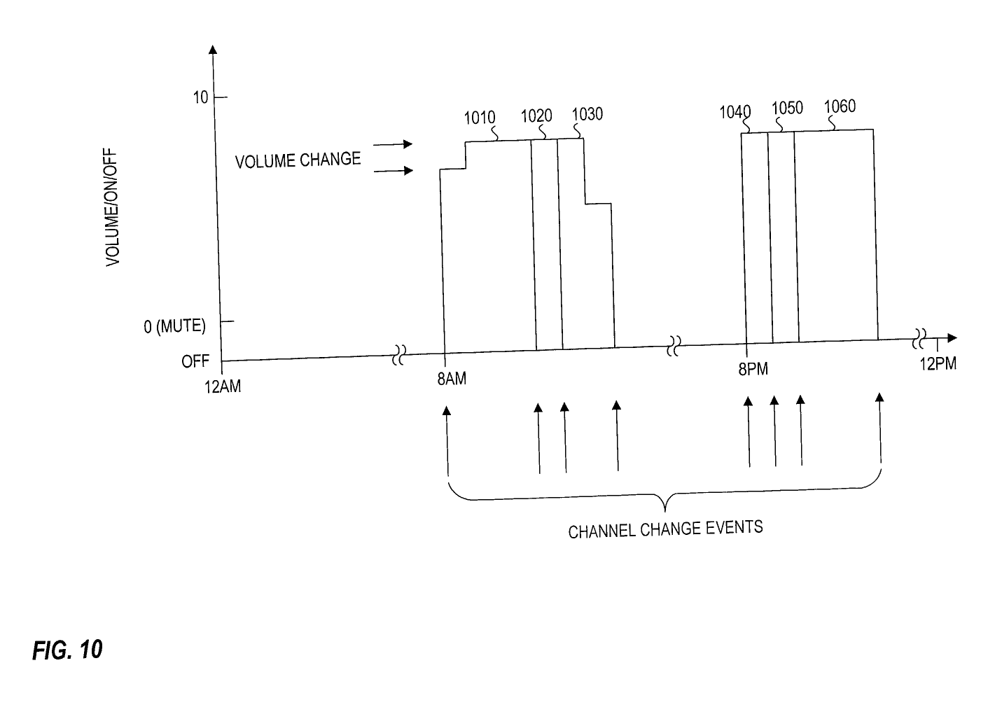

FIG. 10 illustrates an exemplary graphical representation of monitored channel and volume changes for a period of time. The volume is illustrated on the y-axis while time is illustrated on the x-axis. Each window 1010-1060 represents a channel selection with the lines between each window representing the channel change. As illustrated, volume changes were monitored during the program represented by windows 1010 and 1030 respectively. According to one embodiment, the VCPS 700 is configured to ignore commands (i.e., 712, 718) and the associated source material 720 that are simply identified as surfing or scanning. For example, if the subscriber 710 flipped through several channels between window 1010 and window 1020 of FIG. 10, but never stayed on any of the channels for more than a few seconds, the VCPS 700 would not record these channel changes.

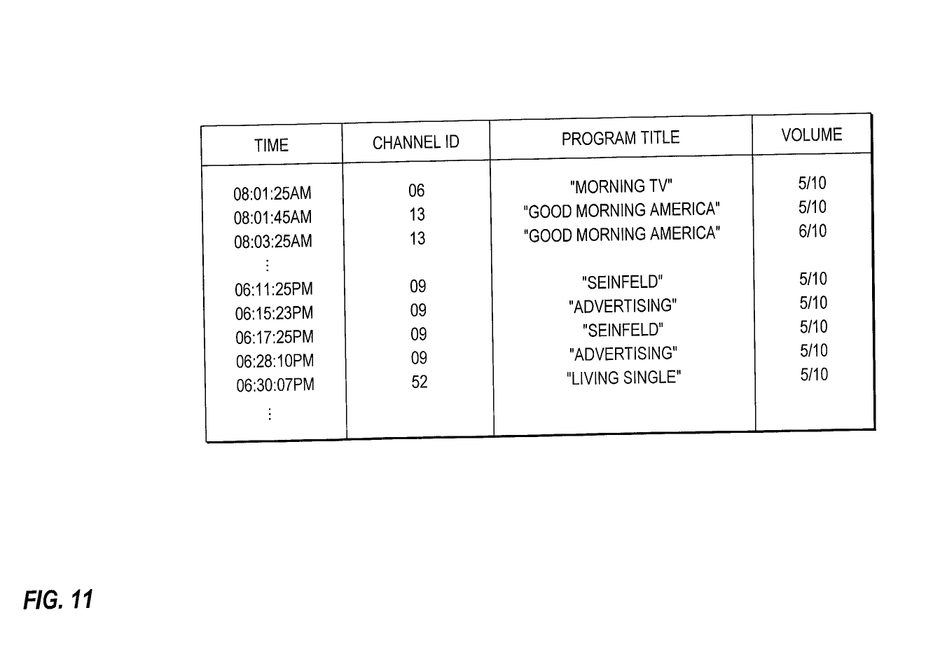

FIG. 11 illustrates an exemplary table of subscriber selection data 730. As illustrated the VCPS 700 only captures time 731, channel ID 732, program title 734, and volume 735 for each activity. As illustrated activities may include channel changes (switching from channel 06 “Morning TV” to channel 13 “Good Morning America”), volume changes (switching from volume 5 to volume 6 during “Good Morning America”), or program title changes (switching from “Seinfeld” to “Advertising” back to “Seinfeld” all on the same channel). FIGS. 10 and 11 are simply exemplary embodiments and are in no way intended to limit the scope of the current invention. Rather, as one of ordinary skill in the art would know, there are numerous implementations of storing subscriber selection data 730 that would be well within the scope of the current invention.

In a preferred embodiment, the subscriber selection data 730 is aggregated, summarized and/or characterized and this aggregated data 742 is used to create viewing characteristics profiles 740. The characteristics may be organized by network, program, program type, time of day, day of week, other parameters that would be obvious to one of ordinary skill in the art, or some combination thereof. The viewing characteristics may be maintained for viewing sessions, a compilation of viewing sessions, set time durations (i.e., 30 day window), for households, individual subscribers, different combinations of subscribers, other parameters obvious to those skilled in the art, or some combination thereof. The viewing characteristics profile 740 may be represented in vector, table or graphical form and can be the basis for targeting ads and creating subscriber groups. When used further herein, the following terms have the following meanings:

“subscriber”—a single subscriber, a household of subscribers, or some combination of subscribers;

“viewing characteristics profile”—characteristics associated with a subscriber that may be generated for a single viewing session or a compilation of viewing sessions; and

“session profile”—a profile, such as a viewing characteristics profile, that is associated with a single viewing session, wherein the initiation and completion of a viewing session can be determined in various manners; and

“signature profile”—a profile that is associated with a compilation of viewing sessions that are determined to be associated with one another.

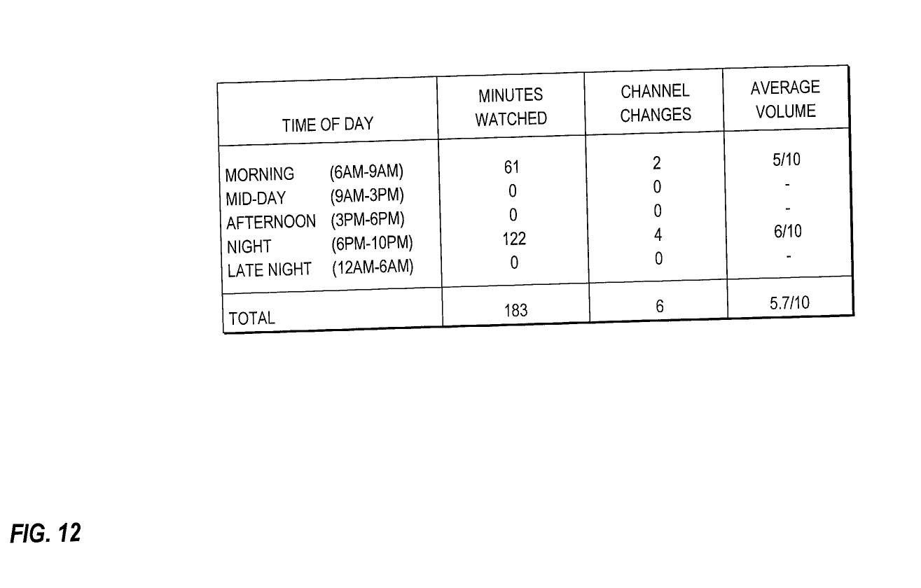

FIGS. 12-16 illustrate exemplary embodiments of viewing characteristics profiles 740. These embodiments are in no way intended to limit the scope of the current invention. FIG. 12 illustrates an exemplary time of day table capturing for certain defined time categories the amount of time the TV (or other device) was watched, the number of channel changes during that time and the average volume. As illustrated this subscriber watches the most TV at the loudest volume during the night (6pm-10pm) timeframe.

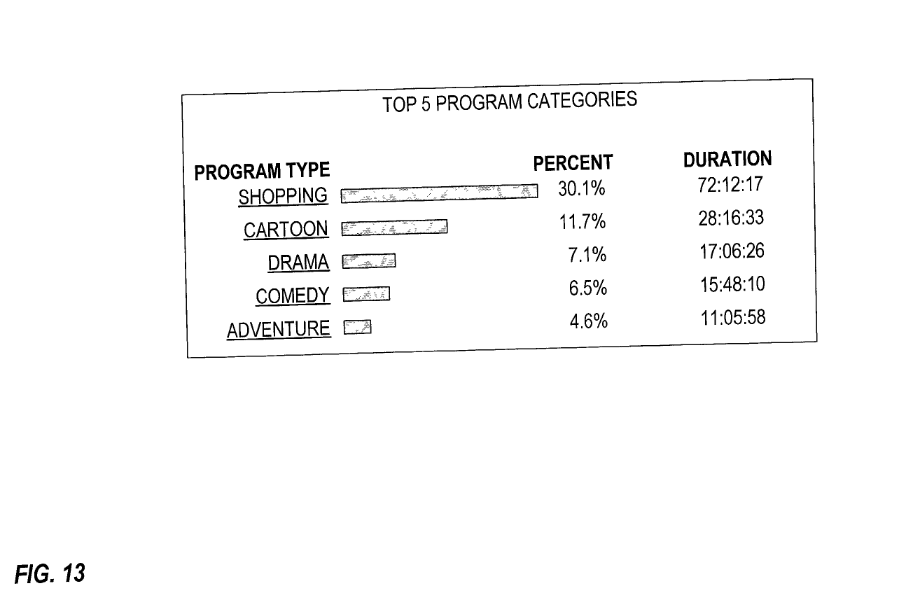

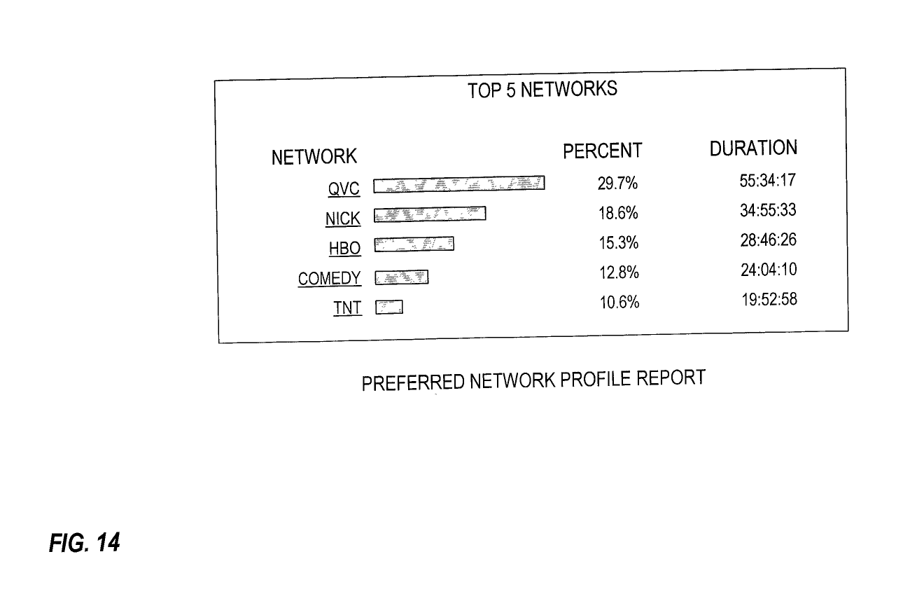

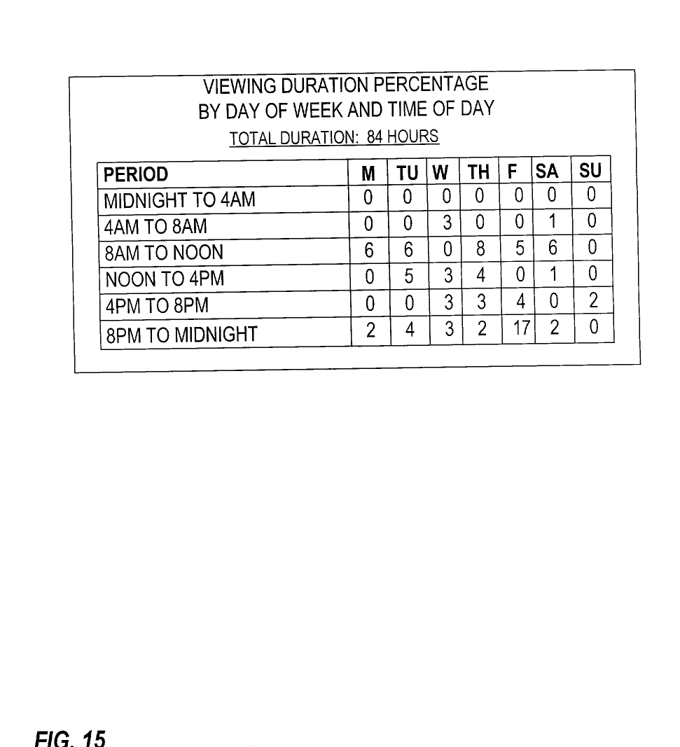

FIG. 13 illustrates an exemplary preferred program category (genre) characteristic profile, reflecting the top five program categories (genres) chosen by this subscriber (or group of subscribers) and the associated relative durations that those program categories were watched. As illustrated, the number one program type (genre) is shopping, which this particular subscriber has viewed over 30% of the time. FIG. 14 illustrates an exemplary preferred networks profile, reflecting the top five networks chosen by this subscriber and relative duration those networks were watched. As illustrated, the number one network for this subscriber is QVC that has been viewed nearly 30% of the time.

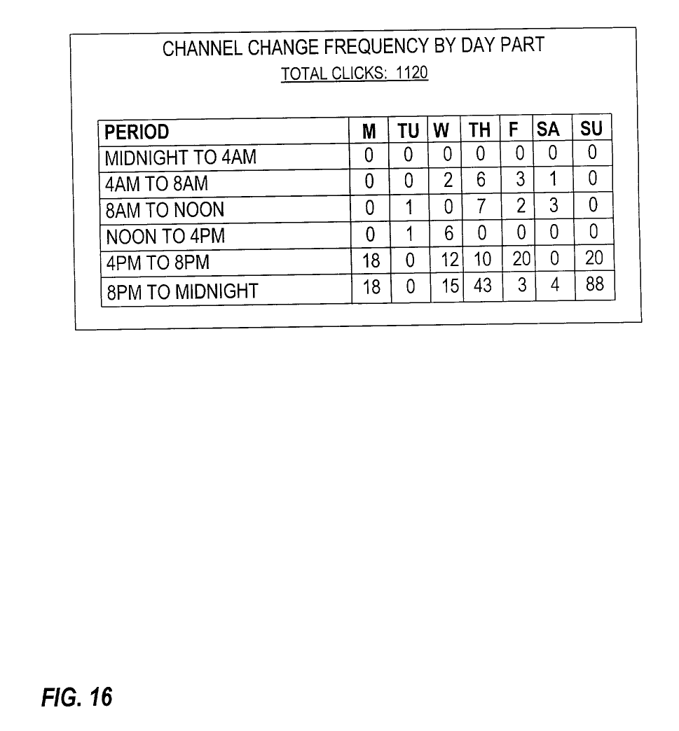

FIG. 15 illustrates an exemplary viewing duration profile by day part. The profile tracks the viewing duration (i.e., in hours) for each period of time for each day of the week. As illustrated, the greatest viewing duration was on Friday between the hours of 8pm and midnight, which had 17 hours out of the total of 84 hours. FIG. 16 illustrates an exemplary channel change frequency by day part profile. The channel change frequency is expressed as the average number of channel changes per time period (i.e., 30 minutes). The profile tracks channel changes and calculates channel change frequency for a given day, during a given period of time. As illustrated, Sunday from 8pm to midnight had the highest channel change frequency at 88 clicks per half-hour.

The collection of subscriber selection data and the generation of subscriber viewing characteristics is further defined in Applicant's co-pending U.S. application Ser. Nos. 09/204,888 filed on Dec. 3, 1998 entitled “Subscriber Characterization System” (Atty. Docket No. T702-00) and 09/205,653 filed on Dec. 3, 1998 entitled “Client-Server Based Subscriber Characterization System” (Atty. Docket No. T703-00). The generation of session characteristics (single viewing session), signature characteristics (compilation of similar session characteristics which may define a subscriber or group of subscribers), and the determination of when a session begins and ends are described in Applicant's co-pending U.S. provisional application Nos. 60/260,946 filed on Jan. 11, 2001 entitled “Viewer Profiling Within a Set-Top Box” (Atty. Docket No. T734-00) and 60/263,095 filed on Jan. 19, 2001 entitled “Session Based Profiling in a Television Viewing Environment” (Atty. Docket No. T735-00). All of these applications are incorporated in their entirety but are not admitted to be prior art.

Referring back to FIG. 6, the purchasing characteristics database 620 may receive input from a variety of sources including, but not limited to, point of sale purchase characteristics 622, Internet purchase characteristics 624, phone purchase characteristics 626, and mail order purchase characteristics 628. Each of the characteristics (622-628) is likely an aggregation, summation or characterization of applicable transaction data (not shown). The characteristics likely provide an insight into characteristics associated with the subscribers (as purchasers). An exemplary characteristic may be that the subscriber normally does their food shopping on Friday evenings. This type of characteristic can be useful to product or supermarket advertisers who may wish to deliver ads for sales on Thursday evening to have the most impact to affect the subscribers decision of where to shop or what to buy.

Subscribers may have their purchases tracked through the use of loyalty cards, credit cards, unique identifications, or other means that would be obvious to one of ordinary skill in the art. It is likely that each store has there own record of purchases made by subscribers. The current invention is designed to be adaptable and work with any combination of purchase transaction databases or purchase characteristics databases that are available, regardless of the number or records, the number of establishments captured, or the types of transactions captured. In a preferred embodiment, each of the databases would have a similar format so that communicating with the plurality of databases is simplified. According to one embodiment, the SPS 550 would interact with a single central purchase characteristics database that characterized multiple purchase transactions for each subscriber (purchaser). Applicant's co-pending U.S. application Ser. No. 09/268,519, filed on Mar. 12, 1999 entitled “Consumer Profiling System” (Atty. Docket No. T706-00), describes in further detail, the collection and aggregation, summation and characterization of subscriber purchases. This co-pending application is herein incorporated by reference in its entirety, but is not admitted to be prior art.

The transaction characteristics database 630 may receive input related to a variety of transaction characteristics including but not limited to credit card transaction characteristics 632, phone transaction characteristics 634, banking transaction characteristics 636 and location transaction characteristics 638. Each of the characteristics (632-638) is likely an aggregation, summation or characterization of applicable transaction data (not shown). These type of transactions are obviously private and government as well as industry regulations govern the privacy concerns associated with collection of this type of data. The current invention anticipates using transaction characteristics that would not violate a subscriber's privacy, but that may be useful to an advertiser in targeting a product or service to the subscriber and thus be beneficial to the subscriber. For example, the credit card transaction characteristics 632 may be that the subscriber uses their credit card only for major purchases, the phone transaction characteristics 634 may be that the subscriber normally makes most of their phone calls in the evenings, the banking transaction characteristics 636 may be that the subscriber writes numerous checks, and the location transaction characteristics 638 may be that the subscriber commutes about an hour to work each day. As one of ordinary skill in the art would recognize, this data is not very obtrusive but could be used to effectively target new products or services likely to be appealing to the subscriber. For example, offering a new credit card with free interest for purchases over $500, offering a new phone plan with more free evening minutes, offering a new banking plan with free checks, offering ads for services within the commuting route.

The gathering of transactions and the generation of characteristics for the credit card transaction characteristics 632, the phone transaction characteristics 634, and the banking transaction characteristics 636 would be obvious to one of ordinary skill in the art. The gathering of data related to location can be done using locating techniques associated with wireless phones. These techniques were developed to satisfy the government's “E-911” regulation that requires wireless providers to be able to determine the location of a wireless phone subscriber dialing 911, and route the call to the appropriate 911 operators. To satisfy this requirement wireless providers were required to enhance their networks to either determine the location of a signal or to receive and process GPS coordinates from wireless devices equipped with GPS chipsets. These features can also be used to categorize locations that subscribers travel to with their wireless device. The generation of location characteristics is defined in further detail in applicant's co-pending U.S. application Ser. No. 09/782,962, filed on Feb. 14, 2001 entitled “Location Based Profiling” (Atty. Docket No. L100-10). This co-pending application is herein incorporated by reference in its entirety, but is not admitted to be prior art.

The statistical information database 640 may be in the form of logical characterizations of subscribers or probabilistic measures of likely characteristics of subscribers. The statistical information for the subscribers may be related to subscriber demographics, interests, psychographics, or other attributes that would be obvious to one of ordinary skill in the art. The statistical information may be based on market segments (i.e., groups of subscribers having similar characteristics). The groups of subscribers may be based on (1) geographic segmentation, (2) demographic segmentation, (3) psychological segmentation, (1) psychographic segmentation, (5) socio-cultural segmentation, (6) use-situation segmentation, (8) benefit segmentation, and (9) hybrid segmentation. More information may be found in a book entitled Consumer Behavior by Leon G. Schiffman and Leslie Lazar Kanuk published by Prentice Hall, New Jersey 1999 which is herein incorporated by reference.

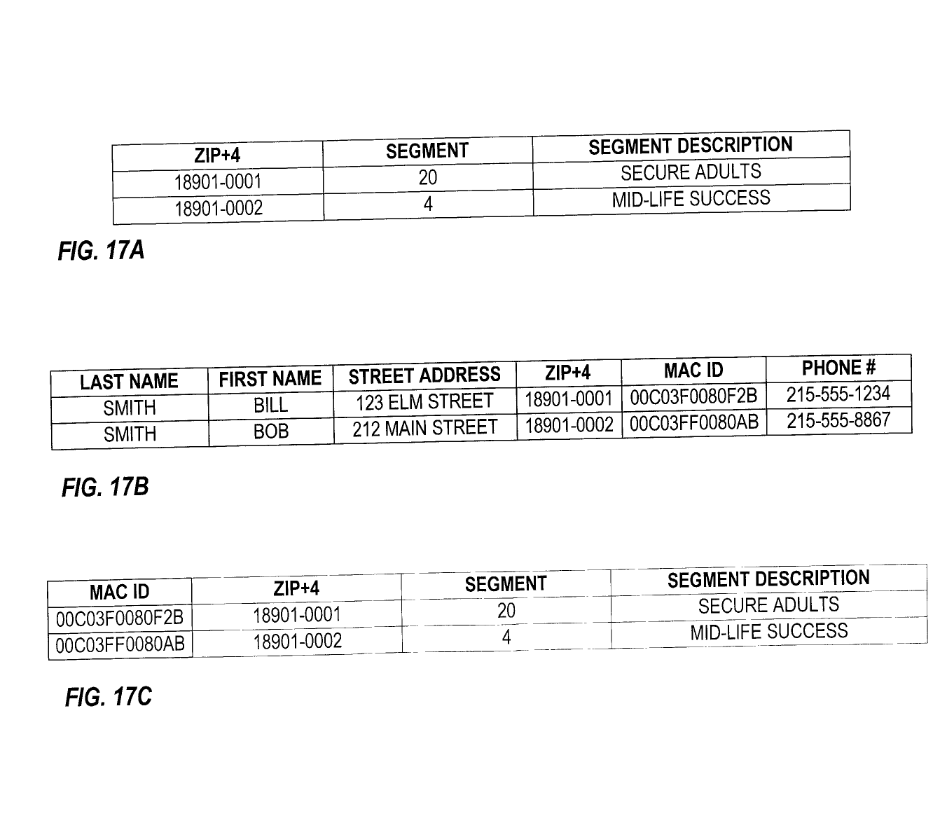

The statistical information may be collected from a variety of sources including private and public databases. For example, MicroVision, a product of Claritas, Inc. of San Diego, Calif. provides demographic segment statistical information for market segments defined by ZIP+4 (approx. 10-15 households). FIG. 17A illustrates an exemplary table showing segment number and segment description for two ZIP+4's. Each segment has an associated demographic makeup associated with it (not illustrated). For example, “secure adults” may be defined as having the highest probability that subscribers are between the ages of 50-54, have no children remaining at home, and make over $100K.

The demographic segment information can be used in the exemplary TV delivery environment of FIG. 5, by combining it with the network operator's billing database. FIG. 17B illustrates an exemplary network operator's billing database including name (last and first), street address, ZIP+4, MAC ID corresponding to the subscribers STB, and phone number. FIG. 17C illustrates an exemplary embodiment of the linked records between the billing database and the demographic segment information. As illustrated, each subscriber is only identified by MAC ID in the linked database of FIG. 17C.

Referring back to FIG. 6, the data within the statistical information database 640 may be generated by applying rules to subscriber transactions or subscriber characterizations, such as those defined in the viewing characteristics database 610, the purchasing characteristics database 620 or the transaction characteristics database 630.

Referring back to FIG. 7, the VCPS 700 retrieves heuristic rules 750 associated with the subscriber selection data 730 and the viewing characteristics 740. The heuristic rules 750, as described herein, are composed of both logical heuristic rules and heuristic rules expressed in terms of conditional probabilities. In a preferred embodiment, the heuristic rules are obtained from sociological or psychological studies and can be changed based on learning within the system or based on external studies that provide more accurate rules.

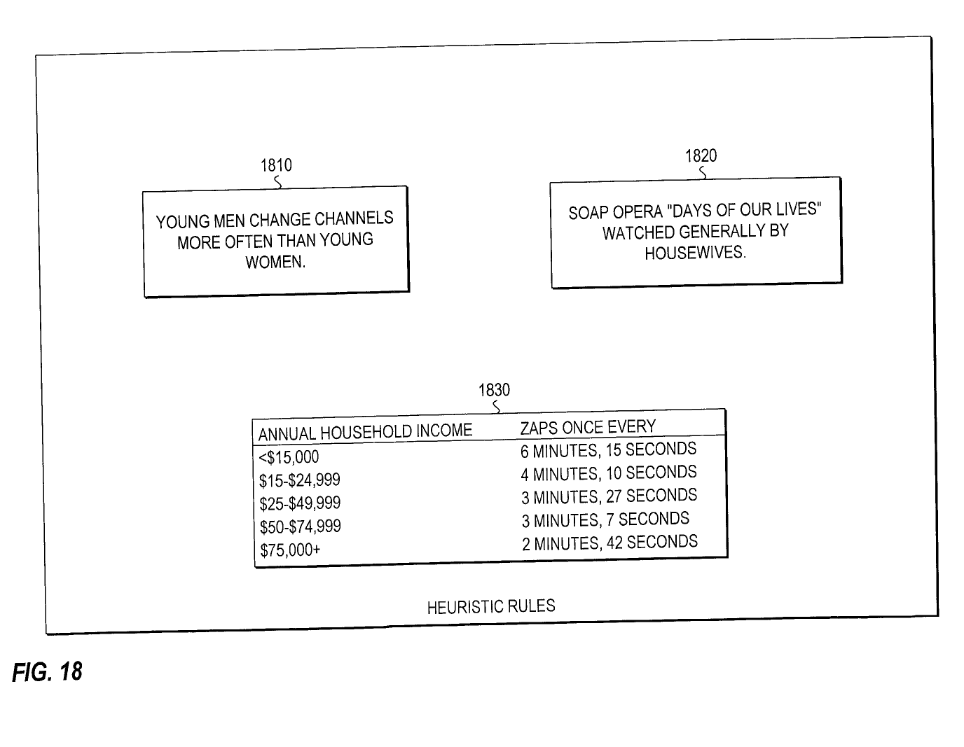

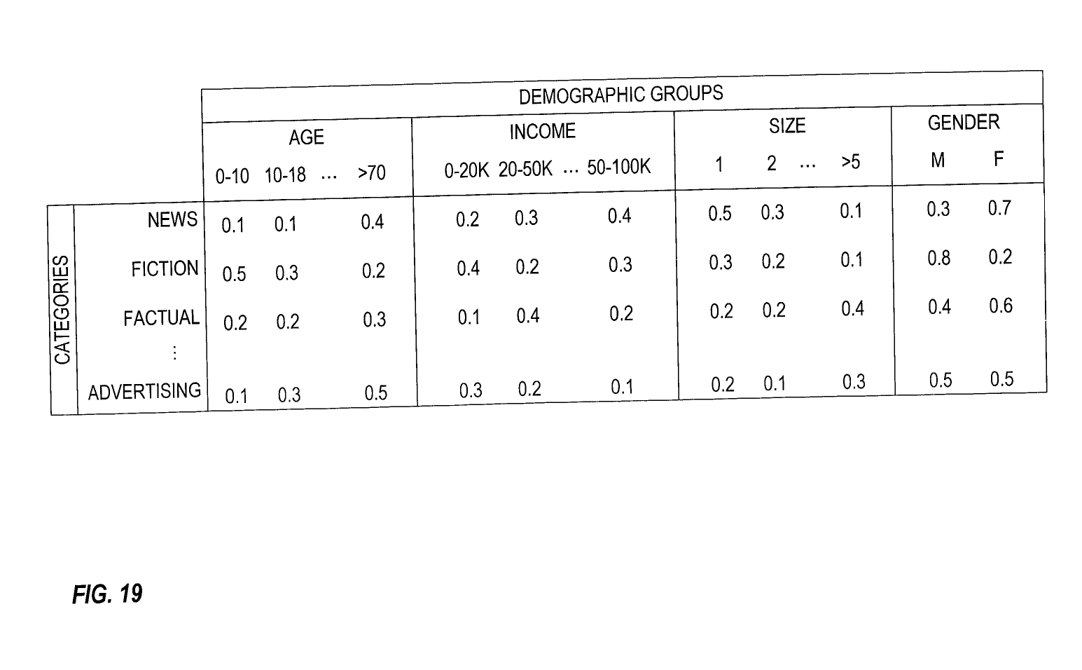

FIG. 18 illustrates exemplary logical heuristics rules. A first rule 1810 associates higher channel change frequency with males. A second rule 1820 associates the viewing of soap operas with a female. A third rule 1830 associates channel change frequency with income. For example, if the subscriber zaps once ever 2 minutes and 42 seconds the rule predicts that the income is above $75,000. FIG. 19 illustrates a set of exemplary heuristic rules expressed in terms of conditional probabilities. For various categories of programming (i.e., news, fiction), there are assigned probabilities of various demographic attributes (i.e., age, income). As illustrated, if the subscriber is watching the news, the highest probability demographic characteristics of the subscriber are that they are over 70 (0.4), make between $50-100K (0.4), are a 1-member household (0.5) and are female (0.7).

The specific set of logical and probabilistic heuristic rules illustrated are in no way intended to limit the scope of the current invention. As one of ordinary skill in the art would recognize, there are numerous logical and probabilistic heuristic rules that can be used to realize the present invention. Moreover, the conditional probabilities associated with different characteristics may vary depending upon the time of day or other criteria.

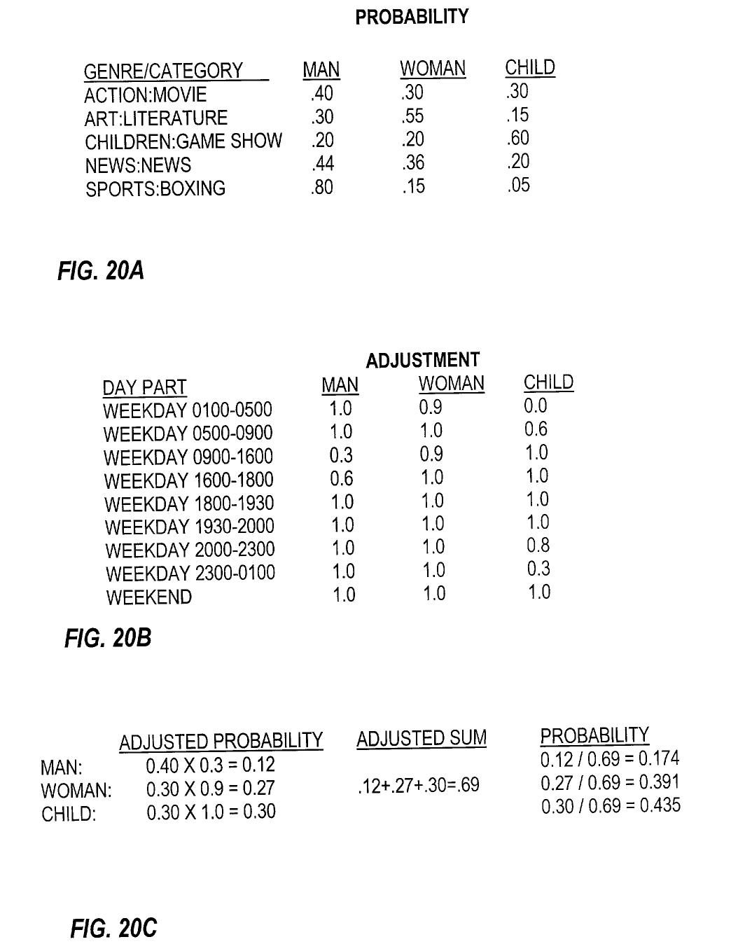

FIGS. 20A-C illustrate an exemplary adjustment of heuristic rules predicting subscriber type (i.e., man, woman or child). FIG. 20A illustrates an exemplary table of probabilities of the subscriber type based on the genre/category of programs. For example, the probability of a man watching an action/movie is 40%, while the probability is 30% for woman and children. FIG. 20B illustrates an exemplary day part adjustment table. An adjustment factor is multiplied by the probability defined in the 20A to determine an adjusted probability. An adjustment value of 1.0 indicates that no adjustment is required, while values smaller than 1.0 will adjust the probability downwards, and values larger than 1.0 will adjust the probability upwards. For example, the adjustment factor for weekdays between 09:00-16:00 is 0.3, 0.9 and 1.0, for men, women and children respectively. FIG. 20C illustrates an exemplary table for normalizing the probabilities. Using a subscriber watching an action movie (respective probabilities of 0.4, 0.3 and 0.3 from FIG. 20A), during daytime hours (respective adjustments of 0.3, 0.9, 1 from FIG. 20B) the subscriber has an adjusted probability of 0.12, 0.27 and 0.3 of being a man, women or child respectively. As illustrated, the adjusted sum is only 0.69, so the adjusted probabilities need to be normalized by dividing by the adjusted sum. The normalized probabilities are 0.174, 0.391 and 0.435 respectively.

As defined in FIGS. 18-20, the heuristic rules define demographic characteristics. However, heuristic rules could also define subscriber interests (i.e., product, program), psychological characteristics, or other attributes that would be obvious to one or ordinary skill in the art. For example, based on the type of programs viewed, times watched, channel change patterns, volume levels or other subscriber activities the heuristic rules could define the probability of a subscriber eating fast food, the type of ads they are receptive to (i.e., emotional, funny, abrasive), or the probability of the subscriber paying for a particular service (i.e., car or house cleaning, oil change) as opposed to doing it themselves. These examples are in no way intended to limit the scope of the invention. As one of ordinary skill in the art would recognize there are numerous applications of heuristic rules that would be well within the scope of the current invention. In a preferred embodiment, the heuristic rules will define attributes not normally associated with the underlying data.

Based on the heuristic rules 750, the subscriber selection data 730, and the viewing characteristics profile 740, the VCPS 700 generates subscriber demographics 762 that are stored as demographic profiles 760. To generate the subscriber demographic profiles 760 weighting factors will have to be applied to the data used to generate the profile. For example, program genres may be given more weight than volume levels. There are numerous weighting scenarios that would be well within the scope of the current invention. The demographic profile 760 may represent a single viewing event or be an aggregation of viewing events. If the demographic profile 760 is an aggregation of viewing events, the demographic profiles 760 may be generated by applying heuristic rules 750 to aggregated subscriber selection data 730 and aggregated viewing characteristics profiles 740 or may be generated by taking a session demographic profile and adding it to existing demographic profiles for the subscriber. If the aggregate demographic profile is generated by adding a current demographic profile to the already existing profile, the demographic profiles need to be combined using weighting factors. An obvious weighting factor is to combine the demographic profiles based on the amount of time represented in each profile. For example, if the existing demographic profile was generated based on 40 hours of data and an additional 10 hours of data was to be added, the existing demographic profile will have a weight of 0.8 (40 hours of the total 50 hours) applied while the new demographic profile would have a weighting factor of 0.2 (10/50) applied.

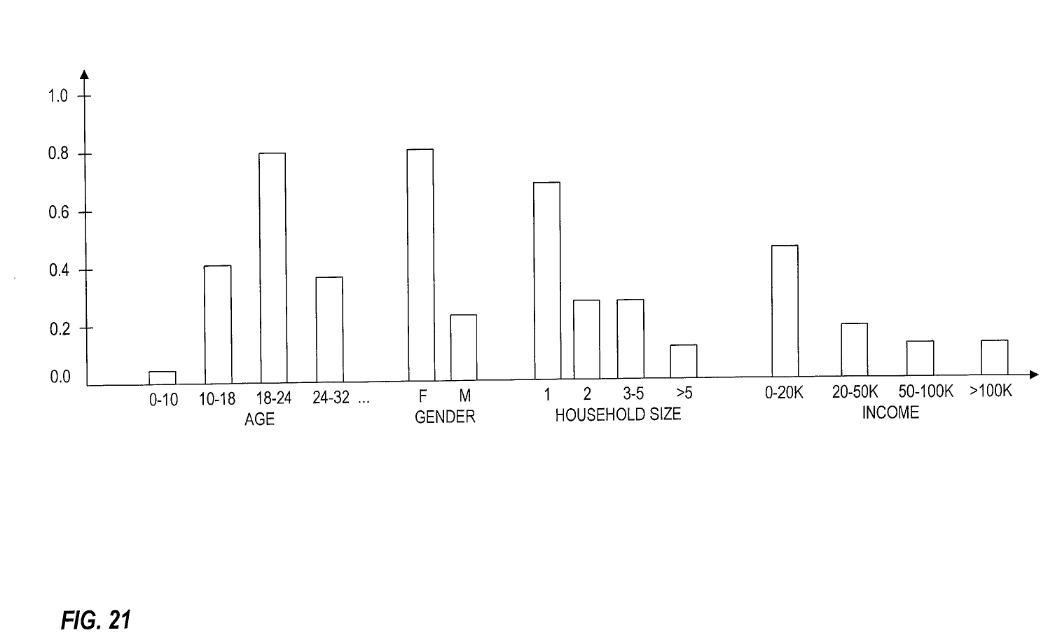

FIG. 21 illustrates an exemplary demographic profile for a subscriber. As illustrated, the subscriber has the highest probable demographic characteristics of being between 18-24 (approx 0.8), female (approx 0.8), a 1 member household (approx 0.7), and making between $0-20K (approx 0.5). As illustrated, the demographic profile is not normalized meaning that the total probabilities for each demographic factor may not total 1. In a preferred embodiment, each of the probabilities for the various demographic characteristics is normalized. One of ordinary skill in the art would recognize how to normalize the demographic profile.

The VCPS 700 may be located within the head-end, the subscribers residence (STB or PVR), a third party location connected to the access network, or some combination thereof. In a preferred embodiment, the VCPS 700 is located in a STB as the STB readily has access to all the subscriber interactions (channel changes, volume levels). The STB can forward the subscriber characterization profiles 740, the demographic profiles 760, other interest profiles (products, programs), all of the above or some portion thereof to the head-end or third party location. For privacy reasons the subscriber selection data 730 would not be forwarded. In one embodiment, the subscribers name will not be forwarded with the profile data but instead some identification code will be used instead. In an alternative embodiment, subscriber interactions (channel changes) are captured at the head-end in an SDV system. In this embodiment, the entire VCPS 700 could be located at the head-end or the third party location.

The following of Applicants co-pending U.S. applications, which are herein incorporated by reference in their entirety, but are not admitted to be prior art, describe in further detail, the application of heuristic rules to generate statistical information, such as a demographic profile, of a subscriber based on their viewing habits:

Application Ser. No. 09/204,888 filed on Dec. 3, 1998 entitled “Subscriber Characterization System” (Atty. Docket No. T702-00);

Application Ser. No. 09/516,983 filed on Mar. 1, 2000 entitled “Subscriber Characterization System with Filters” (Atty. Docket No. T702-02);

Application Ser. No. 09/635,252 filed on Aug. 9, 2000 entitled “Subscriber Characterization based on Electronic Program Guide Data” (Atty. Docket No. T702-04); and

Application Ser. No. 09/205,653 filed on Dec. 3, 1998 entitled “Client-Server Based Subscriber Characterization System” (Atty. Docket No. T703-00).

Heuristic rules can also be associated with purchasing characteristics 620 or transaction characteristics 630 in order to generate statistical information 640. Applicant's co-pending U.S. application Ser. No. 09/268,519 filed on Mar. 12, 1999 entitled “Consumer Profiling System” (Atty. Docket No. T706-00) describes the application of heuristic rules to purchases in order to generate statistical information, such as a demographic profile, of a subscriber based on their purchasing habits. Applicant's co-pending U.S. application Ser. No.. 09/782,962 filed on Feb. 14, 2001 entitled “Location Based Profiling” (Atty. Docket No. L100-10) describes the application of heuristic rules to locations in order to generate statistical information, such as a demographic profile, of a subscriber based on their location habits. Both of these co-pending applications are herein incorporated by reference but are not admitted to be prior art.

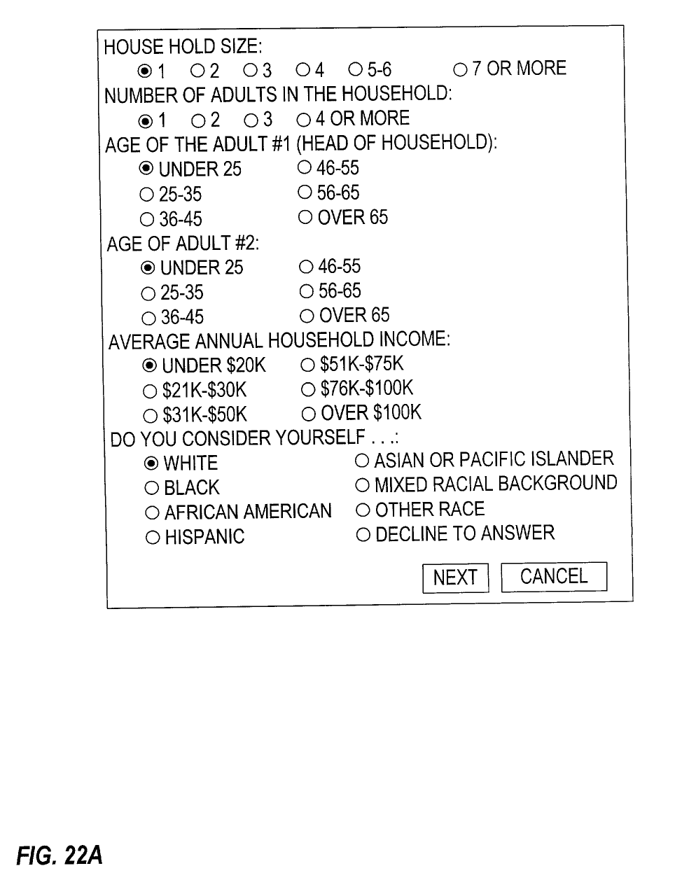

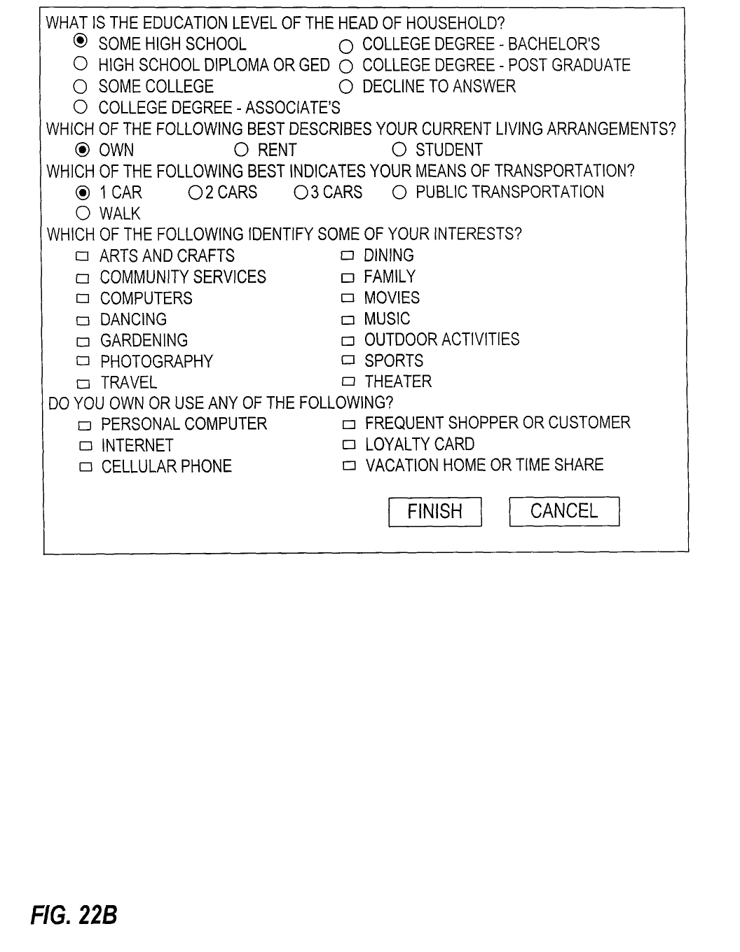

Referring back to FIG. 6, the deterministic information database 650 contains known information about the subscriber such as information the subscriber has provided. The deterministic information may be generated based on the results of a survey that the subscriber agrees to complete. FIGS. 22A-B illustrate an exemplary survey that can be used to determine demographics (household size, ages, income, education), interests and the like.

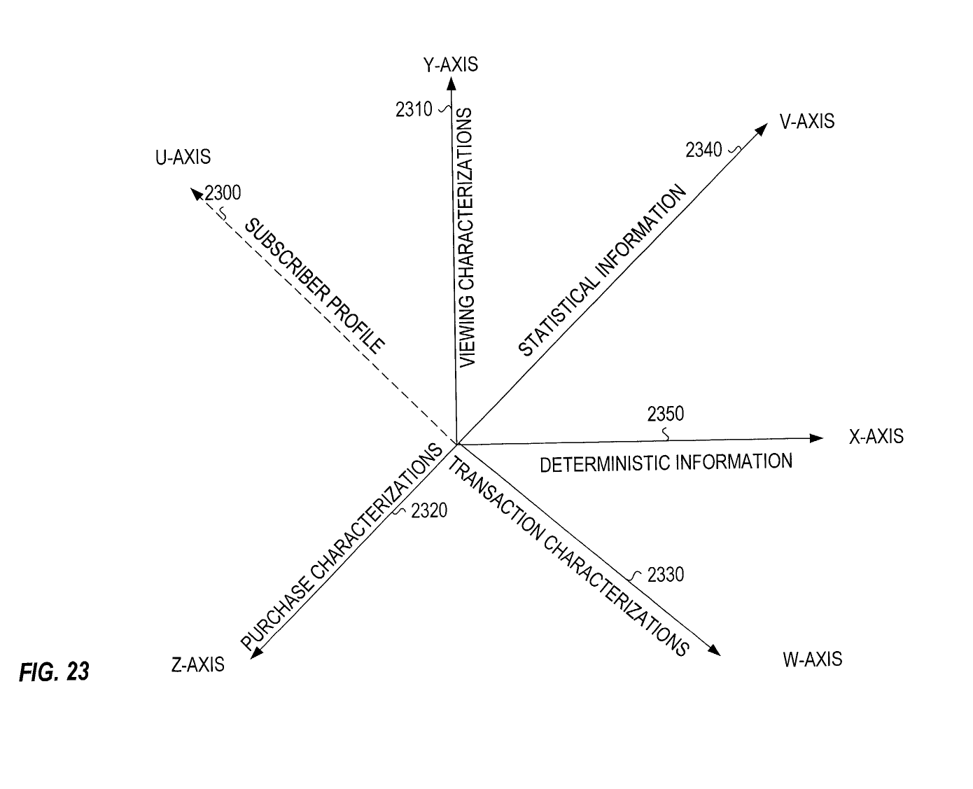

The SPS 550 may gather data from the viewing characteristics database 610, the purchasing characteristics database 620, the transaction characteristics database 630, the statistical information database 640, and the deterministic information database 650, and statistically multiplex it to generate a resulting profile that is used to match subscribers to ads. The profile may be represented as a matrix, graph, or other form known to those skilled in the art. FIG. 23 illustrates an exemplary graphical representation of a subscriber profile 2300 based on the combination of viewing characterizations 2310, purchase characterizations 2320, transaction characterizations 2330, statistical information 2340 and deterministic information 2350. As one of ordinary skill in the art would recognize the subscriber profile 2300 could be weighted to increase or decrease the importance of one or more of the contributing factors or that the profile may be based on only a subset of the factors.

In the actual formation of subscriber profiles, the system may extract information from a plurality of databases and aggregate portions of the information to create a subscriber profile. In the aggregation of data, the emerging standards, such as XML, may be used for the transport of the data and standardized profiles may be utilized to ensure that the SPS 550 may effectively combine the elements of the distributed profiling databases to create a composite subscriber profile.

According to one embodiment of the present invention, the profiles may be generated using Quantum Advertising™ to obtain a probabilistic representation of a subscribers interests in particular products and services. The basis for Quantum Advertising™ is derived from quantum mechanics, and in particular rests on the concept that an individual's information may be treated in a similar fashion to electrons and other subatomic particles. In quantum mechanics, it is possible to have a probabilistic representation of a particle, but impossible to have a deterministic representation in which the precise position of the particle is known. Thus, Quantum Advertising™ allows advertisers to effectively target information to subscribers without revealing specific private information and thus not violating their privacy.

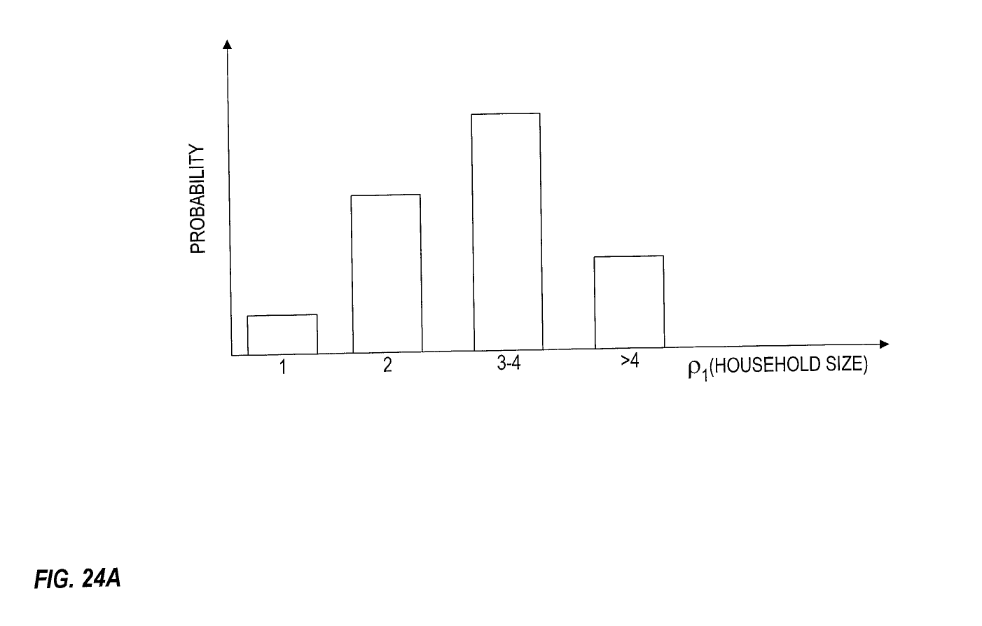

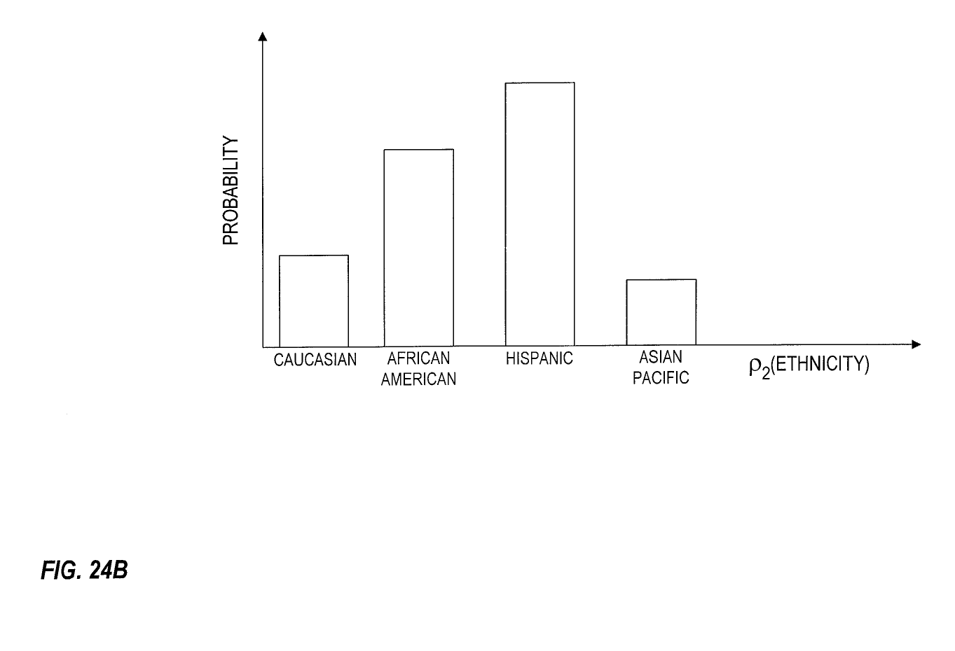

In accordance with the principles of Quantum Advertising™ , the subscriber profile may be contained in a vector, such as a ket vector |A>, where A represents the vector describing an aspect of the subscriber. The ket vector |A> can be described as the sum of components such that

$$\vert A >= ( {a}_{1} {ρ}_{1} + {a}_{2} {ρ}_{2} + … {a}_{n} {ρ}_{n} ) + ( {b}_{1} {σ}_{1} + {b}_{2} {σ}_{2} + … {b}_{n} {σ}_{n} ) + … + ( {e}_{1} {ω}_{1} + {e}_{2} {ω}_{2} + … {e}_{n} {ω}_{n} )$$

wherein a₁ through eₙ represent probability factors and ρ₁ through ωₙ represent characteristics selected from at least a subset of viewing characteristics, purchase characteristics, transaction characteristics, demographic characteristics, socio-economic characteristics, housing characteristics, and consumption characteristics. Each characteristic may be defined by individual traits as well. For example, a demographic characteristic may include traits such as household size, income, and age. FIGS. 24A-B illustrate exemplary components (ρ₁ and ρ₂) of a ket vector.

The different characteristics and traits that make up the ket vector |A> may be stored in a single centralized database or across a set of distributed databases. Consistent with the concepts of wave functions in quantum mechanics, for each ket vector there is a corresponding bra vector <A|. The probabilities are normalized by setting the identity <A|A>=1. Applicant's co-pending U.S. application Ser. No.. 09/591,577 filed on Jun. 9, 2000 entitled “Privacy-Protected Advertising System” (Atty. Docket No. T702-03) describes the concept of Quantum Advertising™ and the generation of subscriber profiles in the form of ket vectors |A> in greater detail. This application is herein incorporated by reference in its entirety but is not admitted to be prior art.

As previously discussed, one method for increasing the efficiency of ads is to deliverer the ads to subscribers that are most interested in the ads (i.e., subscribers in the “quit applicable” and “extremely applicable” categories). Referring back to FIG. 5, the SCS 540 correlates ads and subscribers based on ad characteristics that are received from advertisers and subscriber profiles generated in the SPS 550. The ads may be correlated to individual subscribers or groups of subscribers. If the targeting is to be done per group the groups may be formed based on various profile attributes defined in the SPS 550. For example, groups may be defined by correlating subscribers having similar characteristics including but not limited to demographic characteristics, purchase characteristics, viewing characteristics, or some combination thereof. The groups may be further refined by grouping similar traits defined within the characteristic. For example, traits with a demographic characteristic may include income, household size, age, gender, race or some combination thereof. The groups may be defined by correlating subscribers having similar traits.

If subscribers were to be grouped by demographic characteristics, the demographic characteristics used in order to do the grouping may be obtained from the statistical information database 640 or the deterministic information database 650. For example, the groups may be formed using segment demographic data based on ZIP+4 as received from Claritas (discussed previously). The groups may be formed using numerous methods that would be obvious to one of ordinary skill in the art.

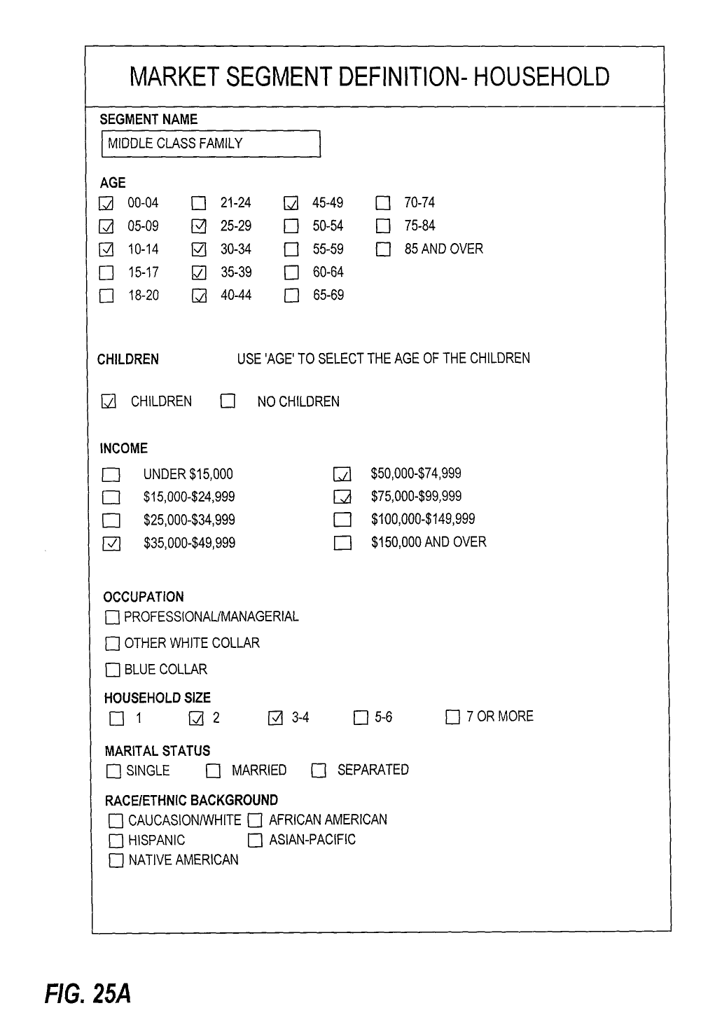

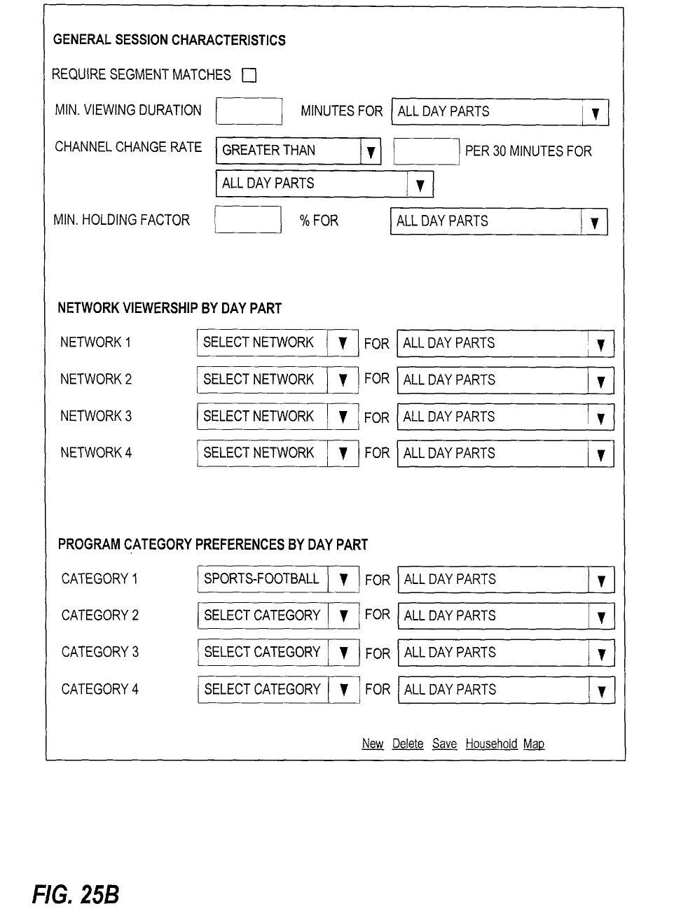

According to one embodiment, the groups are formed to closely correlate with ad characteristics (ad profiles) that are known in advance. The ad characteristics contain a description of the expected characteristics of the target market (i.e., may define a subset of characteristics that include but are not limited to demographic, preference, or transaction characteristics). The ad characteristics may be obtained from the advertiser, a media buyer, or an individual cognizant of the market to which the ad is directed. The ad characteristics may be created by simply filling out a survey (preferably an electronic survey that has selectable answers) that describes the target market by demographic information or by preference information. FIG. 25A illustrates an exemplary questionnaire that may be filed out by an advertiser to define the demographics of the intended target market. FIG. 25B illustrates an exemplary questionnaire that identifies viewing characteristics of the intended target market of the ad (preferred networks, categories, channel change rate).

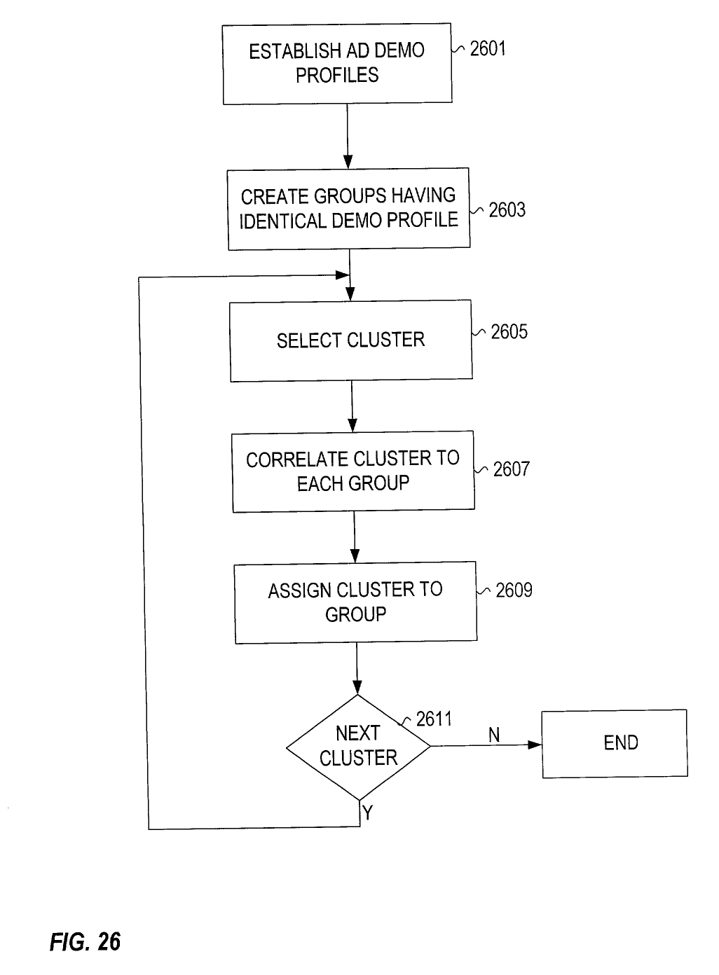

FIG. 26 illustrates an exemplary method for correlating subscribers with know ad characteristics. Initially, a demographic profile of a target audience for each of “n” presentation streams containing targeted advertisements is established (step 2601). An equal number of groups “m” are created that has an identical (or similar) demographic profile (step 2603). A cluster, such as a ZIP+4 demographic cluster as defined by Claritas, is selected (step 2605) and compared to each of the groups to generate a correlation between the cluster and each group (step 2607). The cluster is assigned to the group with the highest correlation (step 2609). A determination is made as to whether there are additional clusters (step 2611). If additional clusters are remaining the process returns to step 2605. If no additional clusters remain the process is complete. As one skilled in the art would recognize, there are other methods for generating groups corresponding to predetermined advertisement demographics that would be well within the scope of the current invention.

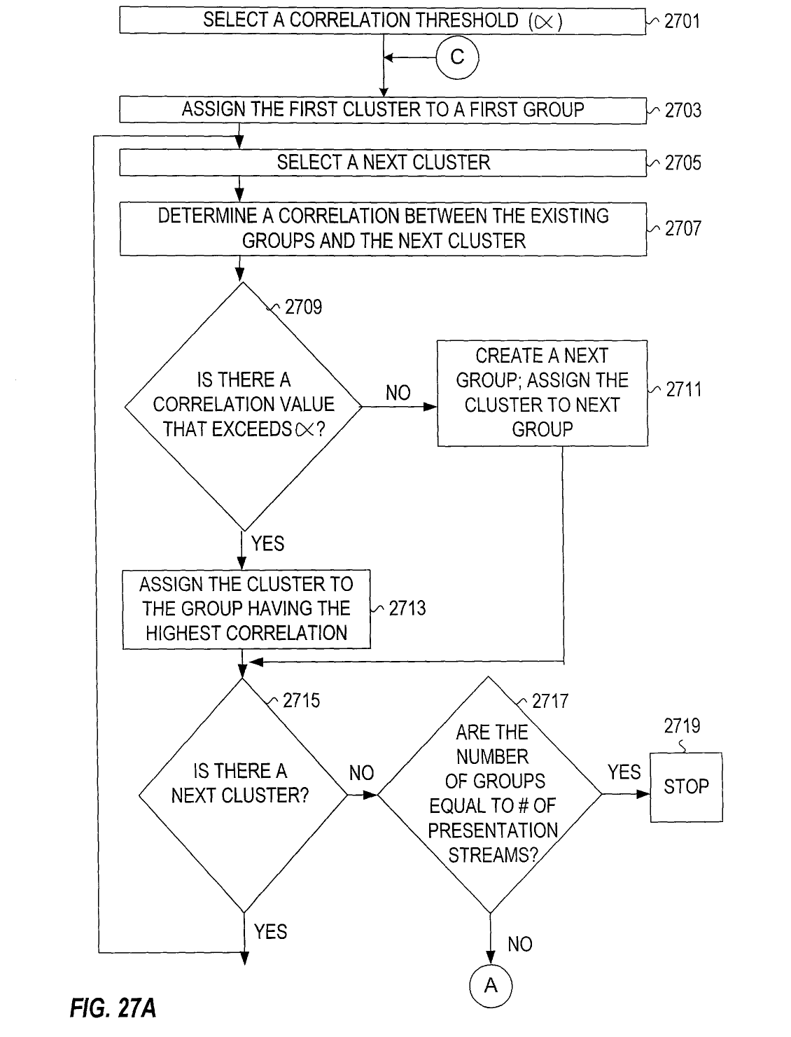

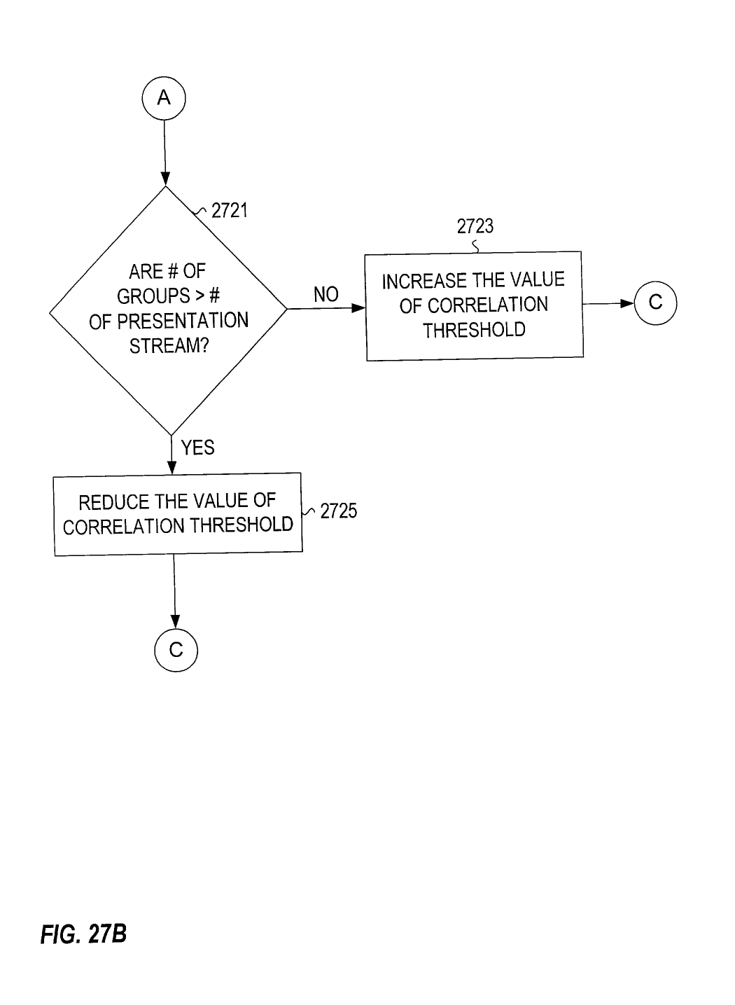

FIGS. 27A-B illustrate an exemplary embodiment for mapping the clusters into subscriber groups given a known number of presentation streams. Initially a correlation threshold ((α) is selected (step 2701). Generally, the correlation threshold (α) is selected based on one or more pre-determined parameters. The advertiser, media buyer or network operator is provided with flexibility to select a value for the correlation threshold (α). A first cluster (which is those individuals having a certain Zip+4 assigned in an embodiment where the demographic database is the Claritas database) is assigned to a first group (step 2703). A next cluster is selected (step 2705) and a correlation between the existing groups and the next cluster is determined (step 2707).

A determination is made as to whether any correlation exceeds the correlation threshold c(α) in step 2709. A determination of NO implies that the cluster does not have a sufficient correlation to any of the existing group(s). Therefore, a new group is created and the cluster is id assigned to the new group (step 2711). A determination of YES implies that a sufficient correlation exists between the cluster and at least one of the existing groups. Therefore, the cluster is assigned to the group with the highest correlation (step 2713). A determination as to whether all the clusters have been checked is then made, i.e., if there remains a next cluster to be examined (step 2715).

If the determination is YES, the process returns to step 2705 and the iteration of steps 2705-2715 is repeated. The iteration of step 2705-2715 continues until all of the clusters have been examined. If the answer to step 2715 is NO implying that all the clusters have been examined, then a determination is made as to whether the number of groups are equal to the number of presentation streams (step 2717). If the answer is YES implying that the desired goal has been reached, i.e., the number of groups is equal to the number of presentation streams, the process ends (step 2719).

If the determination in step 2717 is NO, then a determination is made as to whether the number of groups is greater than the number of presentation streams (step 2721). If the determination in step 2721 is NO implying that the number of groups are fewer than the number of presentation streams, the correlation threshold is increased (step 2723) because as would be obvious to one skilled in the art the higher the correlation factor the more groups that will be created. The iteration of steps 2703-2725 is then repeated. If the determination in step 2721 is YES, the value of the correlation threshold is reduced (step 2725) because as would be obvious to one skilled in the art the lower the correlation threshold the less groups that will be formed. The process then returns to step 2703 to run another iteration of steps 2703-2725. The process ends when a determination is made in step 2717 that the number of groups is equal to the number of presentation streams (step 2719).

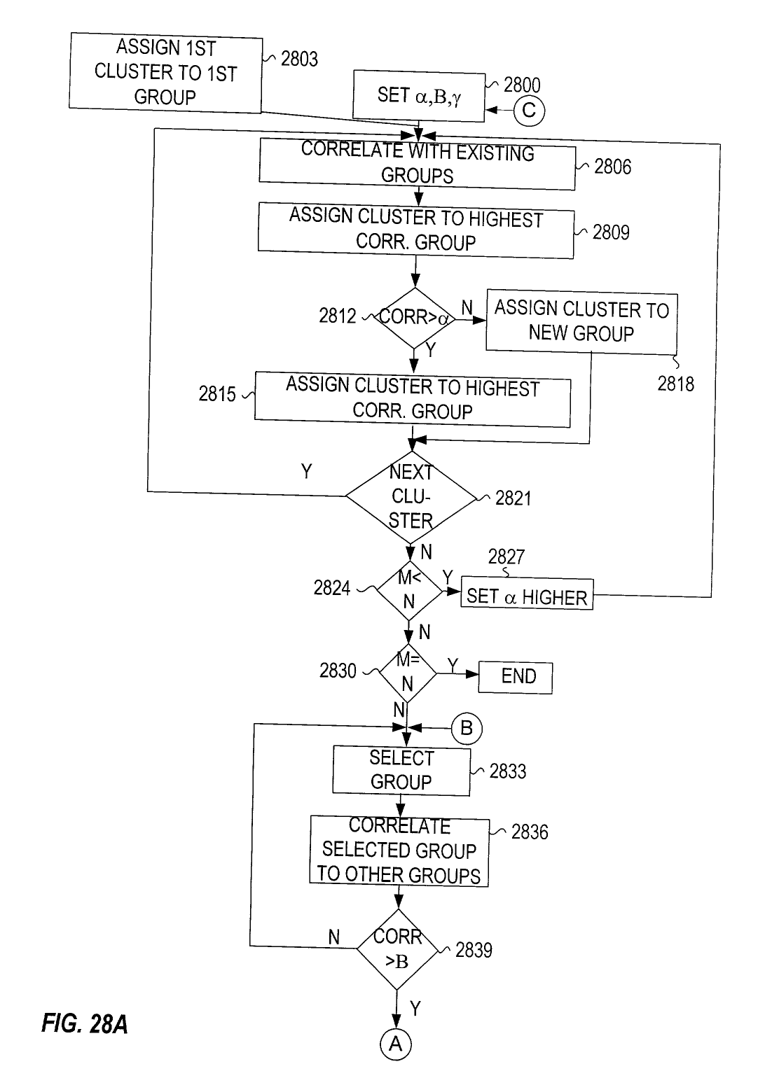

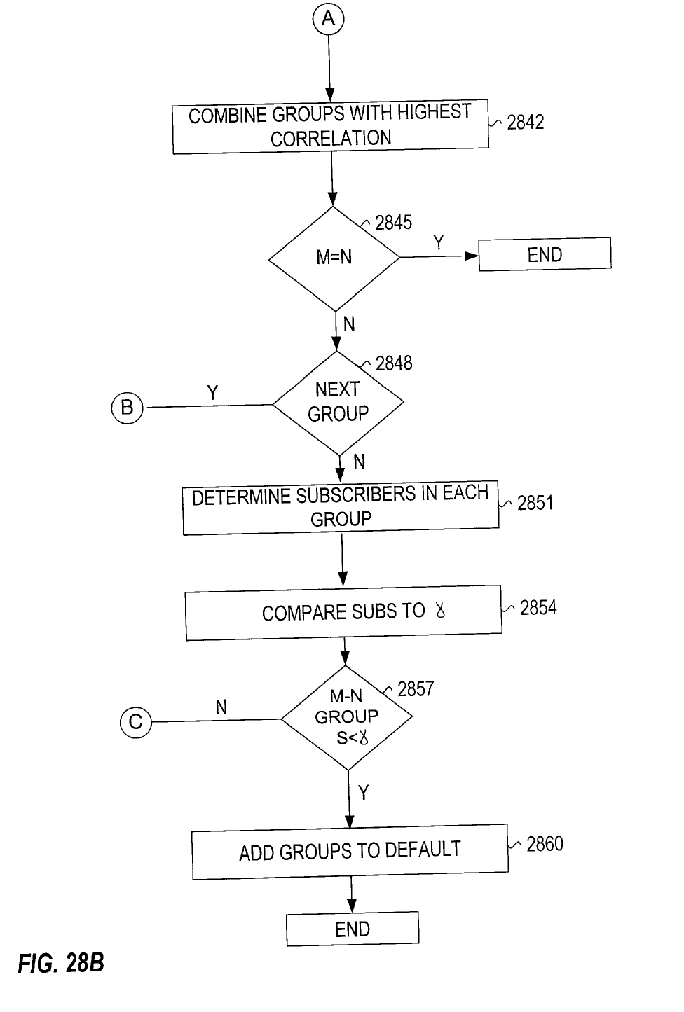

FIGS. 28A-B illustrate an alternative exemplary embodiment for mapping the clusters/segments into subscriber groups given a known number of presentation streams. In this embodiment, initial values are selected for a cluster-to-group threshold (α), a group-to-group threshold (β), and a subscriber-in-group threshold (γ) in step 2800. A first cluster is selected and assigned to a first group (step 2803). A next cluster is selected (step 2806) and is correlated with existing groups (step 2809). A comparison is made to determine if the correlation between the cluster and any existing group exceeds the α threshold (step 2812). If the correlation exceeds the α threshold, the cluster is assigned to the group with the highest correlation value (step 2815). If the correlation does not exceed the α threshold for any group the cluster is assigned to a new group (step 2818).

A determination is made as to whether there are additional clusters remaining (step 2821). If additional clusters remain, the process returns to step 2806. If there are no additional clusters then a determination is made as to whether the number of groups (M) is less than the number of presentation streams (N) in step 2824. If the answer is YES (i.e., M<N) the α threshold is set higher (step 2827) and the process returns to step 2806. If the answer is NO (i.e., M>or=N) then a determination is made if M=N (step 2830). If the answer is YES, the process ends. If the answer is NO, a group is selected (step 2833). The group is correlated with all of the other groups to determine the correlation between each of the groups (Step 2836). A determination is made as to whether the correlation between the groups exceeds the β threshold (step 2839).

If the answer is YES, the groups with the highest correlation are combined with each other (step 2842). A determination is then made as to whether M=N (step 2845). If the answer is YES, the process ends. If the answer is NO implying that M>N a determination is made as to whether additional groups are left to be correlated with the remaining groups (step 2848). If the answer is YES the process returns to step 2833. If the answer is NO, a determination is made as to the number of subscribers in each group (step 2851). The number of subscribers is compared to the γ threshold (step 2854). A determination is made as to whether M-N groups are less than the γ threshold (step 2854). If the answer is YES then the M-N groups are added to the default group (step 2860) and the process ends. If the answer is NO then the process returns to step 2800 where new thresholds (α, β, and γ) are assigned.

While not illustrated in either FIGS. 27 or 28, it would be obvious to one of ordinary skill in the art that the group distribution changes when a new cluster is added to the group (i.e., steps 2713 and 2815). In general the change is based upon a weighting factor based on the number of existing subscribers and newly added subscribers.

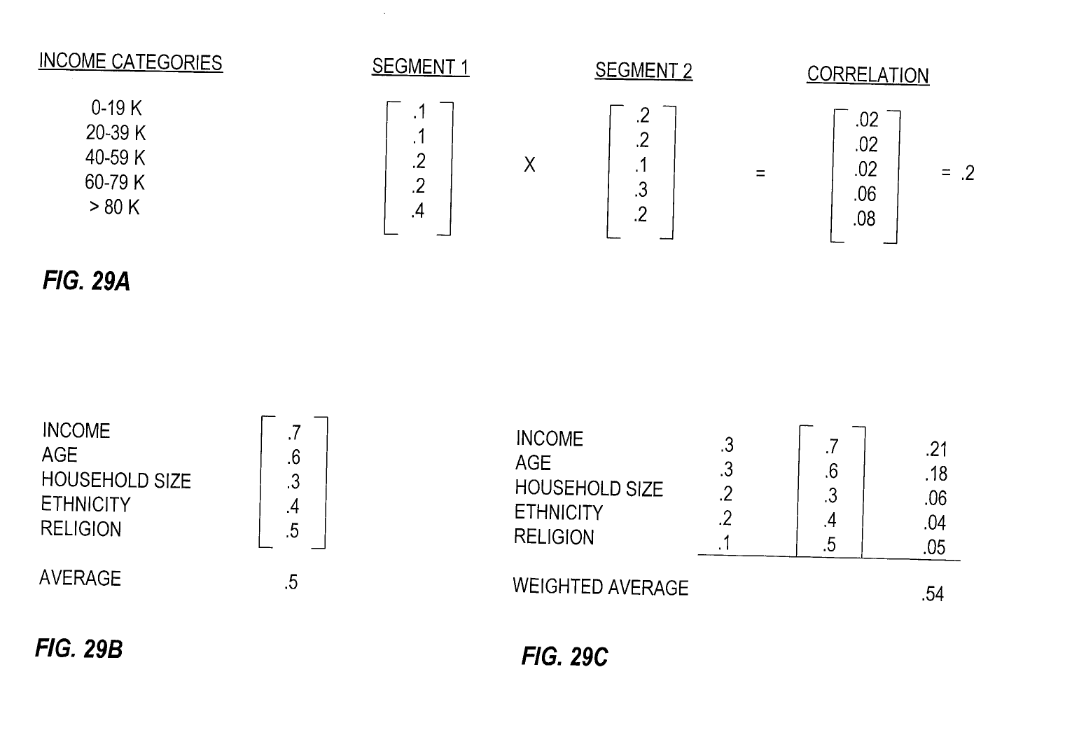

Correlating segments in order to group the segments in clusters can be done using various methods that would be known to those skilled in the art. For example, the segments may be correlated using a scalar dot product if the demographic traits are in the form of probabilities. FIG. 29A illustrates an exemplary scalar dot product between two segments based on the demographic trait of income. As illustrated the scalar dot product is generated by multiplying appropriate category probabilities and then adding the result. For this particular example, there is only a 20% correlation between the two segments as it relates to income. The correlation may be calculated for the entire characteristic by summing the traits that make up the characteristic. FIG. 24B illustrates an exemplary calculation of an average correlation for demographics based on the correlation scores for each trait within demographics. As illustrated the overall demographic correlation is 50%. In generating the correlation score, certain factors may be more important than others and thus require a heavier weighting. FIG. 24C illustrates an exemplary calculation of a weighted average correlation for the same correlation of FIG. 24B. It should be obvious to one of ordinary skill in the art that an overall correlation based on numerous traits and categories can be generated using a methodology like that described above or some iteration thereof.

Applicant's co-pending U.S. application Ser. No.. 09/635,542 filed on Aug. 10, 2000 entitled “Grouping Subscribers Based on Demographic Data” (Atty. Docket No. T719-00) discloses the generation of subscriber groups, with specific emphasis on groups having similar demographic characteristics, in more detail. This application is herein incorporated by reference in its entirety but is not admitted to be prior art.

In addition to correlating the segments in order to form groups, the groups may be formed using other methods that would allow groups be formed based on specific characteristics. According to one embodiment, segments may be grouped together based on a highest probability trait. For example, all segments having the highest probability of the household income being: (1) over $100,000 would be in a first group, (2) between $75,000-$99,000 in a second group and so on. Another embodiment, would group segments together having probabilities of specific traits above a certain probability, such as 50%, together. For example, all segments having a probability of 0.5 or better of being (1) a two member household would be in a first group, (2) income greater that $100,000 in a second group, etc. The above noted embodiments are simply for illustration and are not intended to limit the scope of the current invention. There are numerous other embodiments that would clearly be within the scope of the current invention.

According to another embodiment, the groups may be formed by developing a restricted operator or set of operators (hereinafter simply referred to as an operator) to apply to the subscriber profiles that are in the form of ket vectors |A> . The restricted operator allows the measurement of certain parameters (non-deterministic) to be made, but prohibits the measurement of other parameters (privacy invading determinations). As an example, an operator may be created and utilized that indicates a probability that a subscriber will be receptive to a new drug, such as an HIV related product, but would not allow identification of subscribers in the group, and the database would not contain health related information, such as HIV status.

Having created the basic descriptions of the subscribers in the form of a distributed or centralized database, a series of linear operations may be performed on the database in order to obtain results that provide targeting information. The linear operations may be performed using operators, which when applied to the database, yield a measurable result. It is important to note that by proper construction of the operators, it is possible to prevent inappropriate (privacy violating) measurements from being made. The operators may be used to group or cluster subscribers as well as identify subscribers who are candidates for a product based on specific selection criteria. For example, it is possible to construct an operator which returns a list of subscribers likely to be interested in a product, with the level of interest being determined from probabilistic elements such demographics (age, income), viewing characteristics, purchase characteristics, or transaction characteristics.

The generalized method for obtaining information from the database is, targeting information =<A|f|A>, where f is an operator that results in a measurable quantity (observable). Through the application of the operator it is possible to query the database in a controlled manner and obtain information about a target group. According to one embodiment, it is possible for an advertiser to determine the applicability of an ad to a subscriber (individual/household) or group by supplying an ad characterization vector along with the ID of the subscriber or the group. The generalized method for determining ad applicability is, ad applicability =<A|AC{ID}|A>, where AC{ID} is an ad characteristic that is to be correlated with a particular ID. The ID may be for a particular subscriber (social security #, address, phone #), for particular transactions (anonymous transaction IDs), or groups (zip code, area code, town, cable node). The use of subscriber ID allows a determination of the applicability of an ad for a particular subscriber (household or individual). Anonymous transaction IDs may be used when no information regarding the identity of the subscriber is being provided, but when transaction profiles have been developed based on the use of anonymous transaction profiling. Group IDs may be utilized to determine applicability of an ad to a particular group, with the basis for the grouping being geographic, demographic, socioeconomic, or through another grouping mechanism.

Applicant's co-pending U.S. application Ser. No.. 09/591,577 filed on Jun. 9, 2000 entitled “Privacy-Protected Advertising System” (Atty. Docket No. T702-03) describers the use of operates to determine ad applicability and generate groups of subscribers in more detail. Applicant's co-pending U.S. application Ser. No.. 09/796,339 filed on Feb. 28, 2001 entitled “Privacy-Protected Targeting System” (Atty. Docket No. T715-10) discloses the use of anonymous transaction identifications. These applications are incorporated by reference in their entirety, but are not admitted to be prior art.

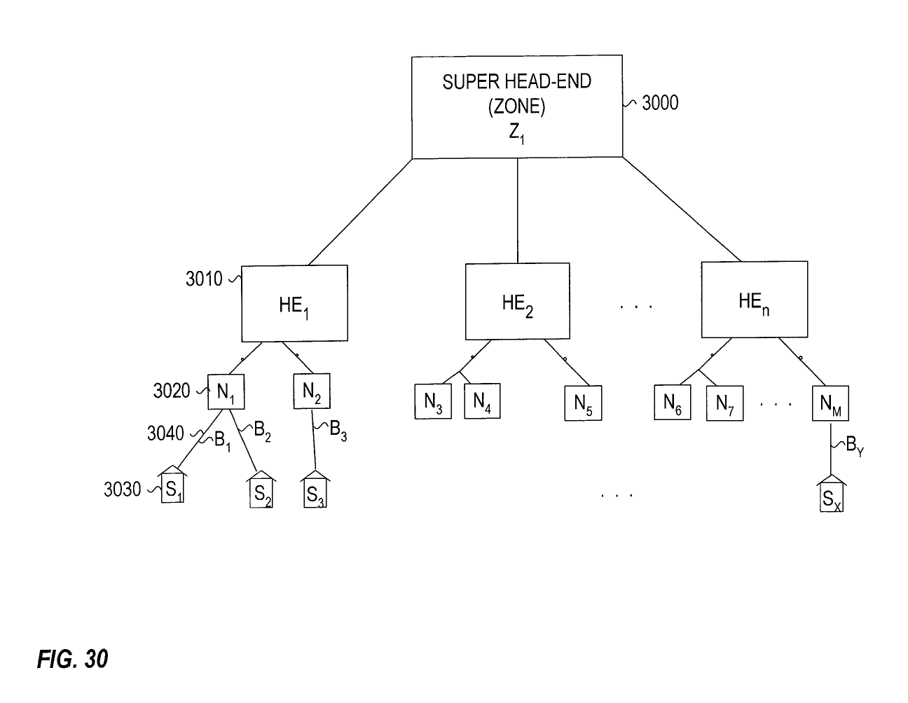

According to one embodiment of the current invention, groups made be formed based on the layout of a CTV plant. As illustrated in FIG. 30, a typical CTV network can be viewed hierarchically. A zone or super head-end (Z₁) 3000 receives national programming via satellite or other means from content providers and distributes the national programming to a plurality of head-ends (HE₁ . . . HEₙ) 3010. Each HE 3010 serves a number of nodes 3020. As illustrated, a fiber optic cable connects the HE to a single node (i.e., HE₁ to N₁) or a group of nodes (HE₂ to N₃ and N₄). When the term node is used hereinafter it may reflect a single node or a group of nodes (node group) that are connected to a HE 3010 via a fiber optic cable. Each node 3020 serves a plurality of subscribers 3030 via a plurality of branches 3040 from each node 3020. The number of subscribers 3030 varies for different systems, but generally each node 3020 serves 150 to 750 subscribers 3030.

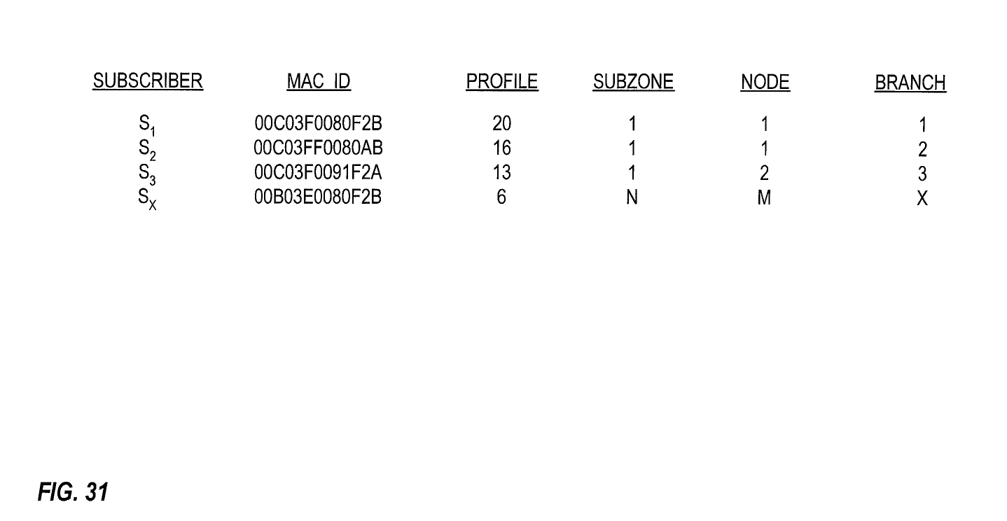

The subscribers 3030 may be grouped by head-end (subzone) 3010, node (microzone) 3020 or branch 3040. Regardless of how the subscribers 3030 are grouped it is necessary for there to be a correlation between each subscriber 3030, their respective profile, and each head-end 3010, node 3020 or branch 3040 respectively. FIG. 31 illustrates an exemplary table correlating subscribers S1-S4 of FIG. 30, with their MAC-ID, a profile (may be a segment profile as defined by Claritas or other profile type), and the subzone (head-end) 3000, node (microzone) 3020, and branch 3040 that are connected to within the CTV system. As illustrated, if groups were formed based on the subzone subscribers S1-S3 would be in one group while subscriber Sx would be in another group. If groups were formed based on node, subscribers S1 and S2 would be in a first group, subscriber S3 would be in a second group and subscriber Sx would be in a third group. If groups were formed based on branch, each subscriber S1-Sx would be in there own group.

According to one embodiment, the subscribers 3030 may be grouped per head-end (subzone) and an average profile may be generated for subscribers within the subzone (subzone profile). The subzone profile may be complex or simple and may be based on some or all of the characteristics described above. That is, the subzone profile may simply be a demographic profile based on commercially available demographic data obtained from Claritas, SRC or other sources. Alternatively, the subzone profile may be based on demographics (obtained from commercially available sources, calculated based on various transactions, or a combination thereof), subscriber preferences (viewing, purchasing), other characteristics well known to those skilled in the art, or some combination thereof. The subzone profile may simply be an average of the profile for each household within the subzone or it may be a weighted average based on the number of subscribers within each household. As one skilled in the art would recognize, there are numerous methods for generating the subzone profile that would be well within the scope of the current invention.

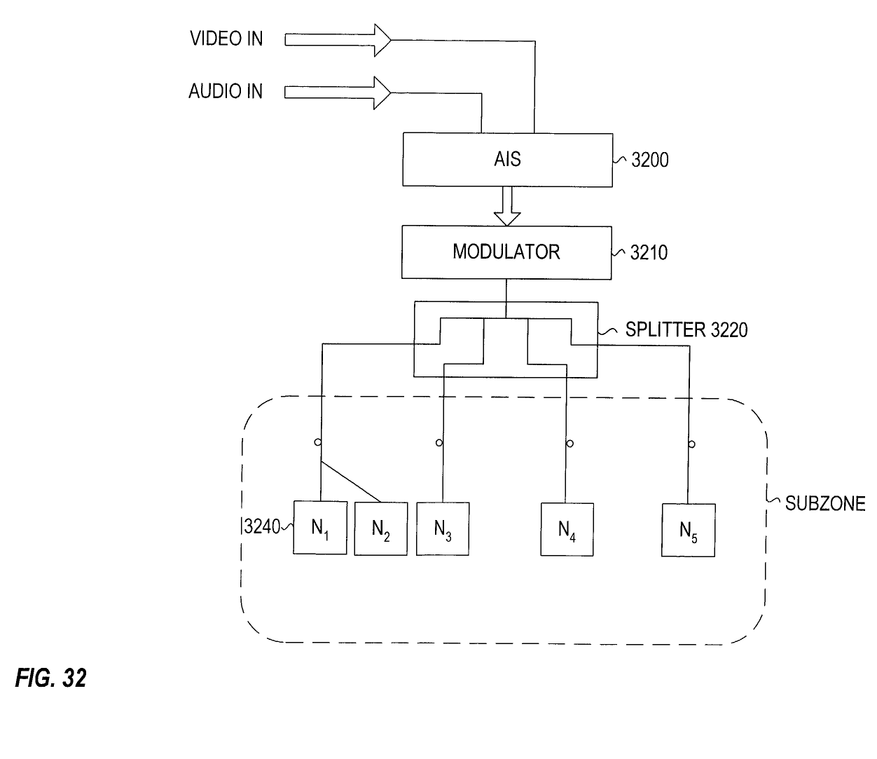

Ads may be targeted to the subscribers within the subzone based on the subzone profile. That is, targeted ads would be those ads whose target audience had a profile that was highly correlated with the subzone profile. In order to target ads at the subzone level it is necessary for the head-end (subzone) to be able substitute ads. Thus, as illustrated in FIG. 32 each head-end requires an ad insertion system (AIS) 3200 capable of inserting targeted ads for the default ads, a modulator 3210 for modulating the signals at the appropriate frequency, and a splitter 3220 for splitting the signal so that it can be transmitted to each of the applicable nodes. As illustrated nodes N1, N2 are connected to the HE with the same fiber optic cable. The presentation stream (program stream with targeted ads) is transmitted to all nodes being fed from the HE, all branches from each node, and all subscribers connected to each branch.

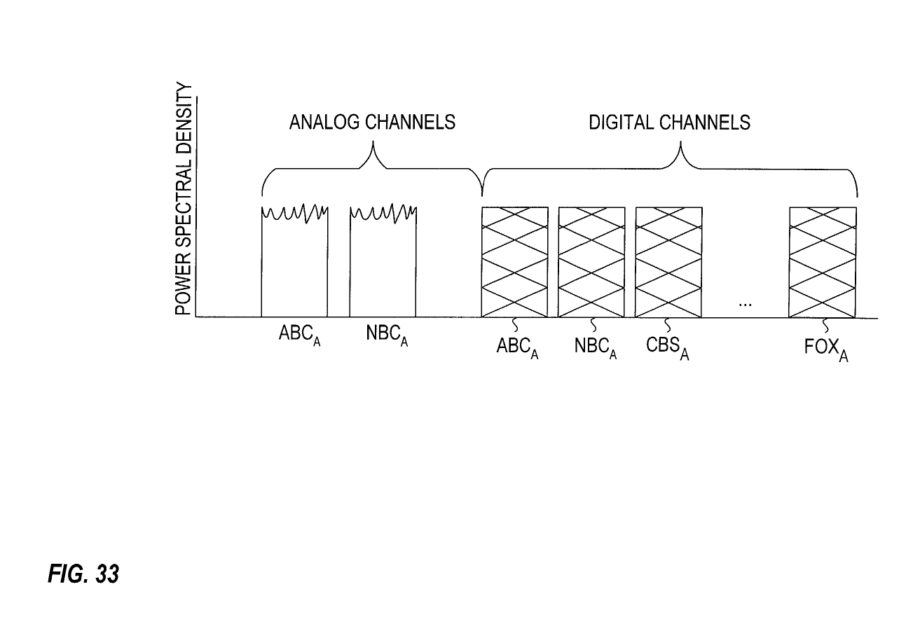

The ad insertion can be performed for analog or digital program streams as one of ordinary skill in the art would recognize. Moreover, analog, digital, or a combination of program signals are transmitted from the head-end, with the subscribers receiving the applicable signals based on their service. FIG. 33 illustrates an exemplary spectral allocation of analog channels at 152 the lower end of the spectrum and digital channels at the upper portion of the spectrum. As illustrated, both the analog and digital channels had targeted ads substituted (represented by the ABCA etc). The targeted ads are not necessarily the same ads but are ads that are targeted to the subzone profile.

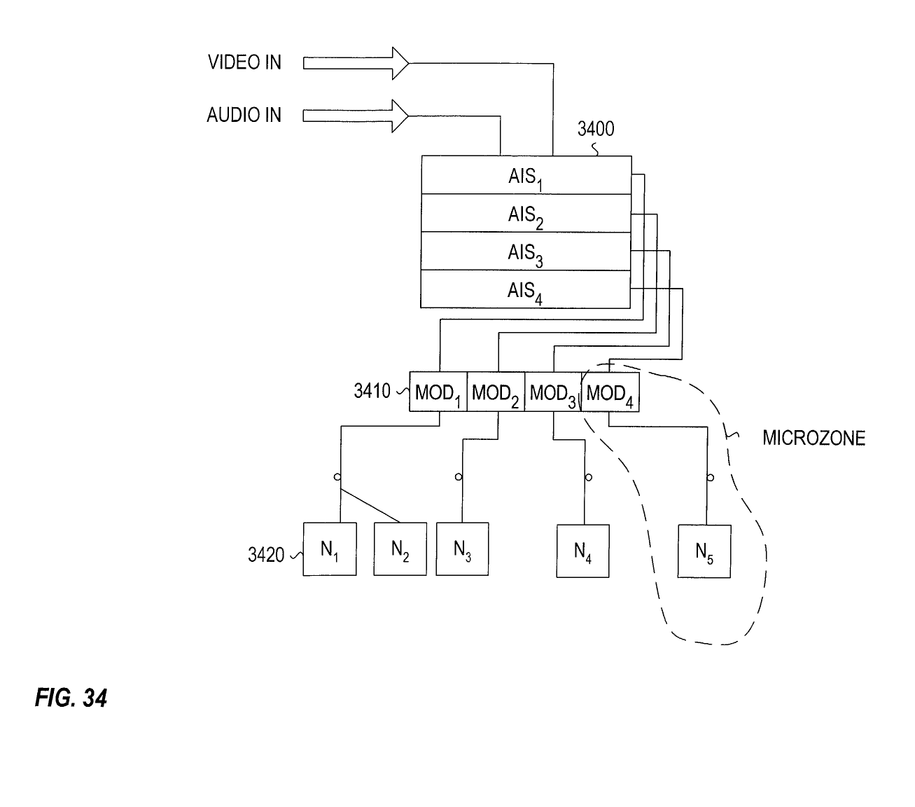

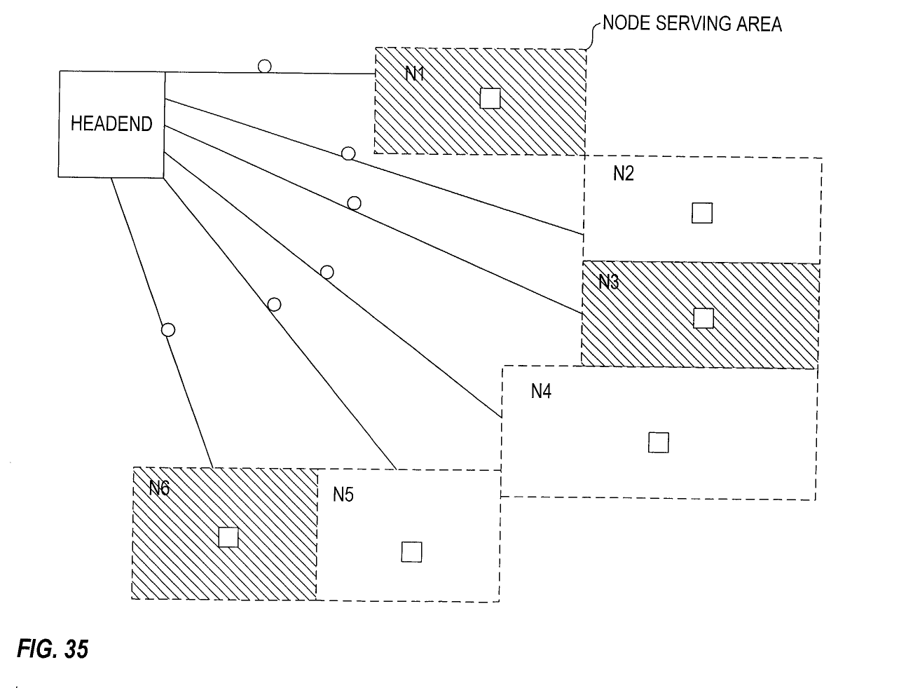

According to one embodiment, subscribers may be grouped per node (microzone) and an average profile may be generated for subscribers connected to the node (microzone profile). As discussed above with respect to the subzone profile, the microzone profile may be simple or complex and may be based on some or all of the characteristics previously discussed. The node profile is an aggregate profile of all the subscribers within the node. In order to target ads to the microzone each head-end must have a plurality of AISs. As illustrated in FIG. 34, the head-end consists of 4 separate AISs 3400 so that 4 separate presentation streams (program stream with targeted ads) can be generated. The head-end also includes a plurality of modulators 3410, equal in number to the number of AIS 3400, for modulating the presentation streams at the appropriate frequencies. Each presentation stream (program stream with targeted ads) is transmitted to the applicable nodes 3420, all branches of the nodes, and all subscribers connected to each branch. The ad insertion can be performed for analog or digital program streams and analog, digital, or a combination of program streams are transmitted from the head-end, as one of ordinary skill in the art would know (FIG. 33). In another embodiment (not illustrated) the program stream (with the default ad) can still be transmitted to certain nodes if it is determined that the default ad is more applicable to certain groups than the targeted ads.

In the illustrated embodiment, the number of AISs 3400 matches the number of fiber optic cables transmitting signals from the head-end to different nodes (or node groups) 3420. However, as one skilled in the art would recognize it is possible that the head-end will feed a large number of nodes and that it would be impractical, and likely not beneficial, to generate a separate presentation stream for each node. Thus, it is likely that a maximum number of presentation streams is generated, for example five, and that the nodes are clustered together based on a correlation and that each cluster of nodes receives a different presentation stream. The cluster of nodes is not limited to geographic proximity. FIG. 35 illustrates an exemplary node clustering. As illustrated there are two clusters of nodes and each cluster would have a cluster profile computed and could receive targeted ads based on the cluster profile. The first cluster is the shaded region that includes nodes N1, N3 and N6 and the second cluster includes nodes N2, N4 and N5.

Correlating node profiles with each other or with ad profiles, may form clusters. There are numerous methods of correlating node profiles that would be well within the scope of the current invention. For example, node profiles may be compared with each other and the nodes that are the most similar are combined. Similarity may be determined by using a scalar dot product of profile characteristics. Alternatively, nodes that have the highest similarity in certain traits of the profile may be combined. If the clusters are formed by correlating node profiles with ad profiles, the maximum number of clusters possible is the number of ad profiles presented. However, as one of ordinary skill in the art would recognize, it is possible that the number of clusters will be less than the number of ad profiles or that some of the ad profiles have a minimal number of subscribers identified therewith. In these cases, fewer than the maximum number of presentation streams may be generated, some of the clusters may receive the default ads, or the ad profiles may be modified. If correlating node profiles forms the clusters, it is possible that the number of clusters is greater than or less than the number of presentation streams. If it is less, then fewer than the maximum number of presentation streams may be generated or the correlation thresholds may be increased to increase the number of clusters. If the number is more, then the number of clusters can be reduced by reducing correlation thresholds, or by combining some of the clusters based on their similarity to each other. The above examples of correlating profiles are in no way intended to limit the scope of the invention.

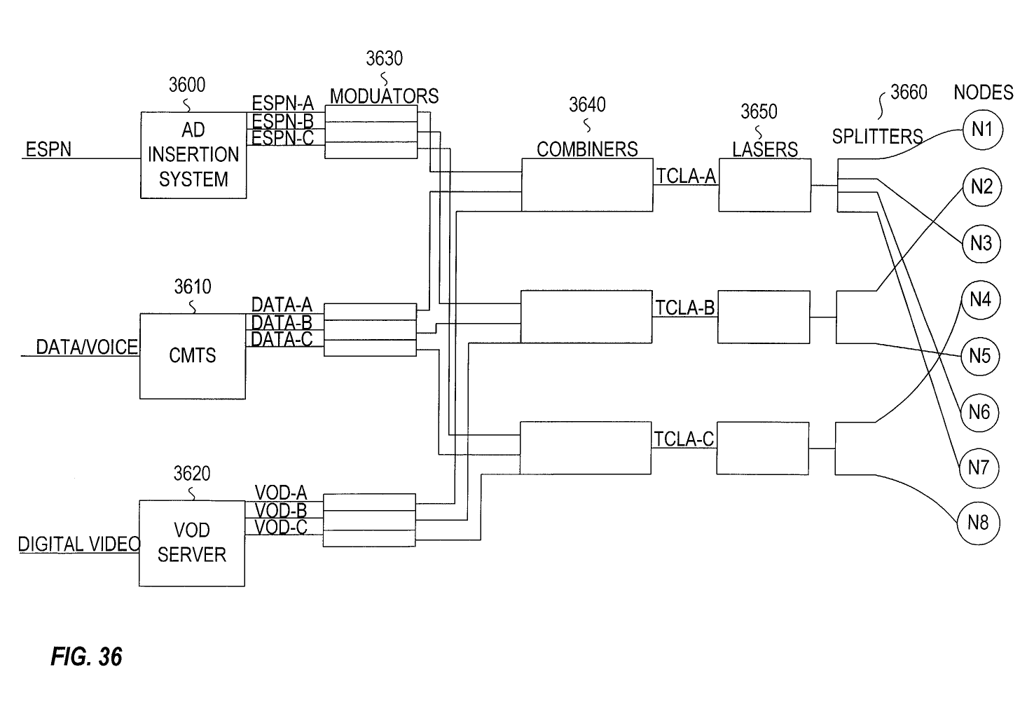

FIG. 36 illustrates another exemplary embodiment of the current invention. As illustrated, the concepts of the current invention for clustering nodes can be used to create targeted channel lineups (TCL) that may include in addition to different presentation streams, different data/voice signals and different video on demand (VOD) signals. As illustrated, an AIS 3600 creates three separate presentation streams, a cable modem termination system (CMTS) 3610 creates three separate data signals, and a VOD server creates three separate VOD signals. The various signals are modulated at the appropriate frequencies by modulators 3630. The appropriate sets of signals are then combined together (i.e., ESPN-A, DATA-A and VOD-A) to form TCLs. The TCLs are then transmitted to the nodes using optical lasers 3650. Splitters 3660 split the optical signal so that the TCLs can be transmitted to the appropriate cluster of nodes. As illustrated, nodes N1, N3, N6 and N7 receive TCL-A, nodes N2 and N5 receive TCL-B, and nodes N4 and N8 receive TCL-C.

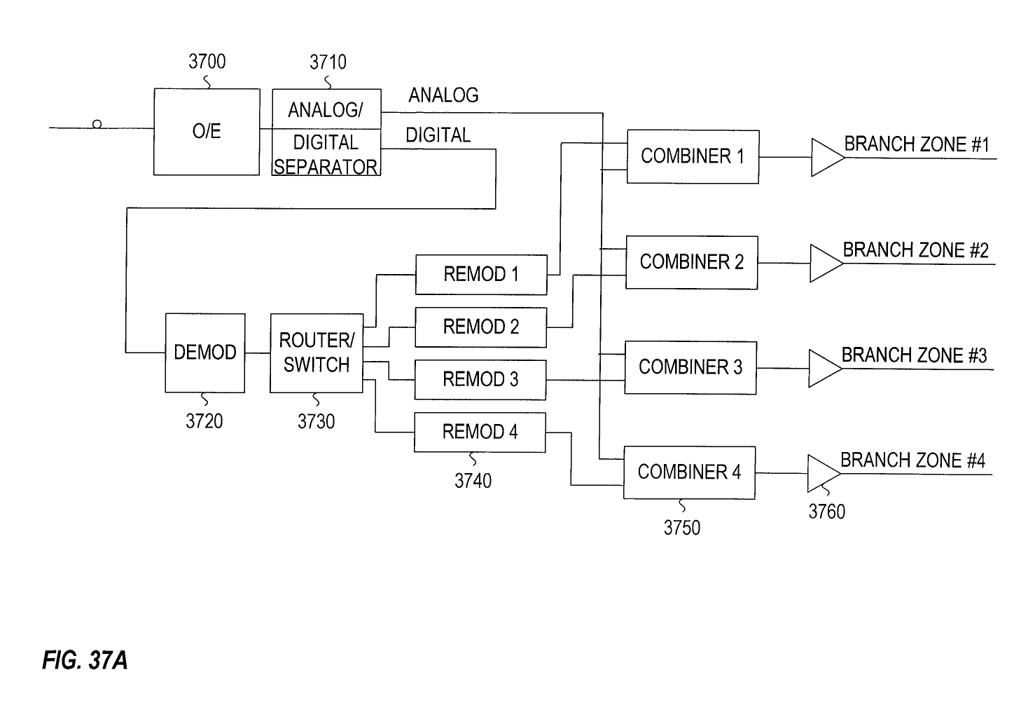

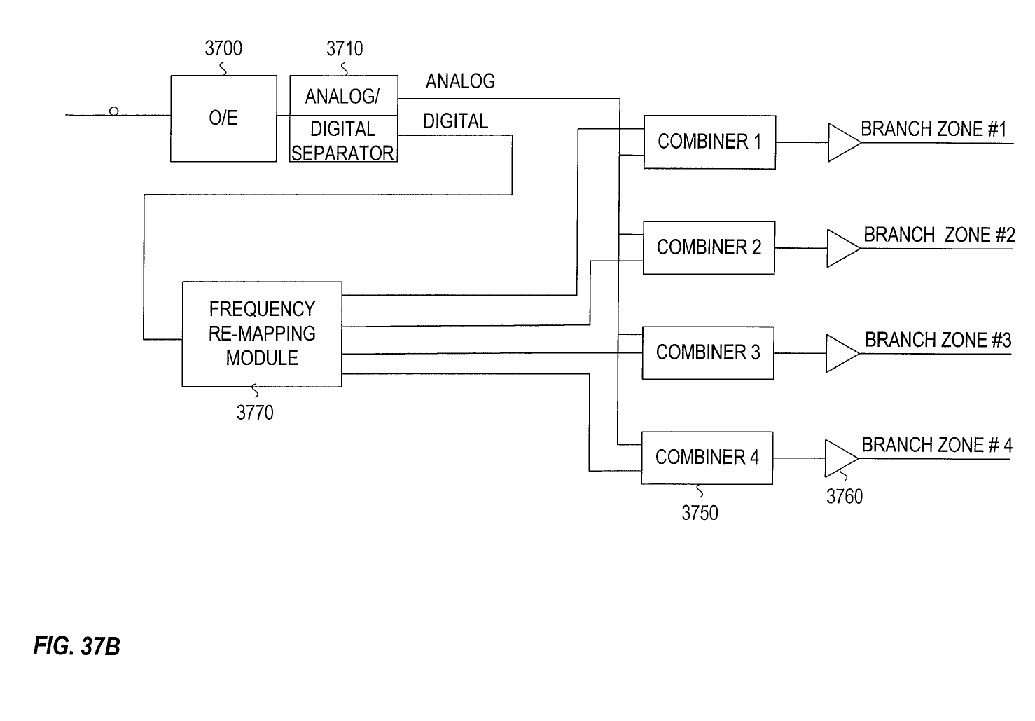

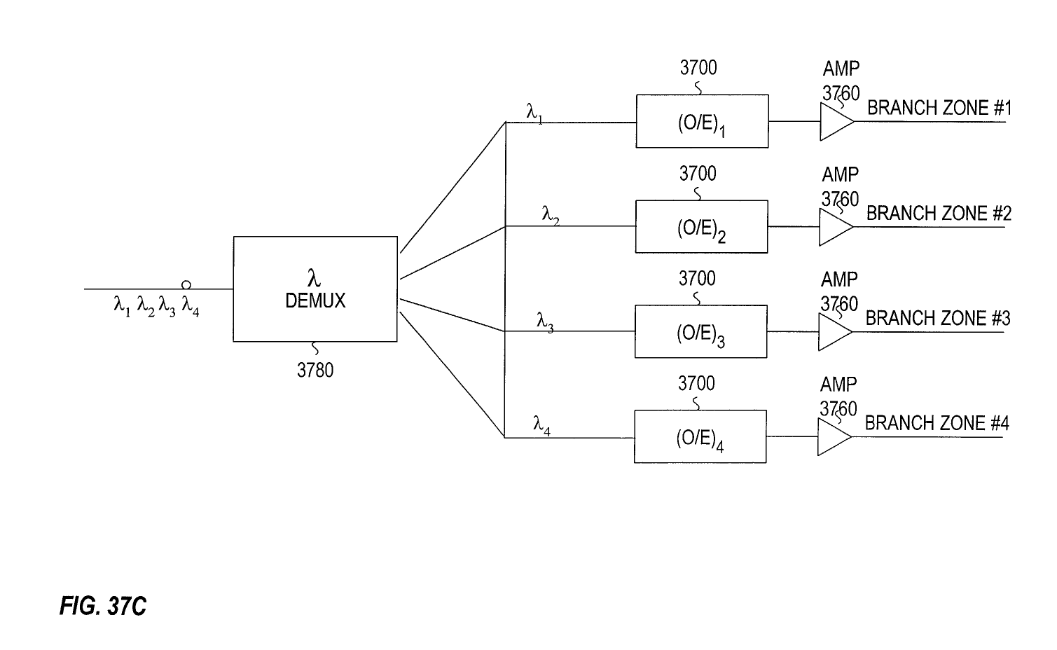

According to one embodiment, subscribers may be grouped by branch. In order to do this, it is necessary for each node to either be able to insert ads or to receive multiple presentation streams for the same program stream (at either different frequencies or different wavelengths) and be able to forward the appropriate presentation stream to the appropriate branch. FIGS. 37A-37C illustrate exemplary embodiments of nodes capable of transmitting different presentation streams to different branches.

Referring to FIG. 37A, an O/E 3700 transmits an electrical signal to an analog/digital separator 3710, which separates the analog signals from the digital signals. In one embodiment, the analog/digital separator 3710 is a frequency-dividing unit that splits off the frequencies carrying the analog signals from the frequencies carrying the digital signals. Such a frequency-separating unit can be constructed using high pass and low pass filters and is well understood by those skilled in the art. The digital signals are received by a demodulator 3720 that demodulates the signals and recreates the baseband digital signals. The baseband digital signals are received by a router/switch 3730 that determines which signals should be routed to each branch zone and how to separate the appropriate channels for transmission to the branch zone. Generally, each router/switch 3730 is connected to four remodulators 3740. The remodulators 3740 are further connected to combiners 3750, wherein each of the combiners 3750 receives an analog input from the separator 3710 and a digital input from the remodulator 3740. The combiner 3750 then generates a channel output based on both inputs, which is forwarded to an amplifier 3760 for distribution to a branch zone. In the exemplary embodiment of FIG. 37A, only the digital program streams are illustrated as having targeted ads inserted therein. As one of ordinary skill in the art would recognize, ads could be substituted in the analog program streams as well or only in the analog stream without departing from the scope of the current invention.

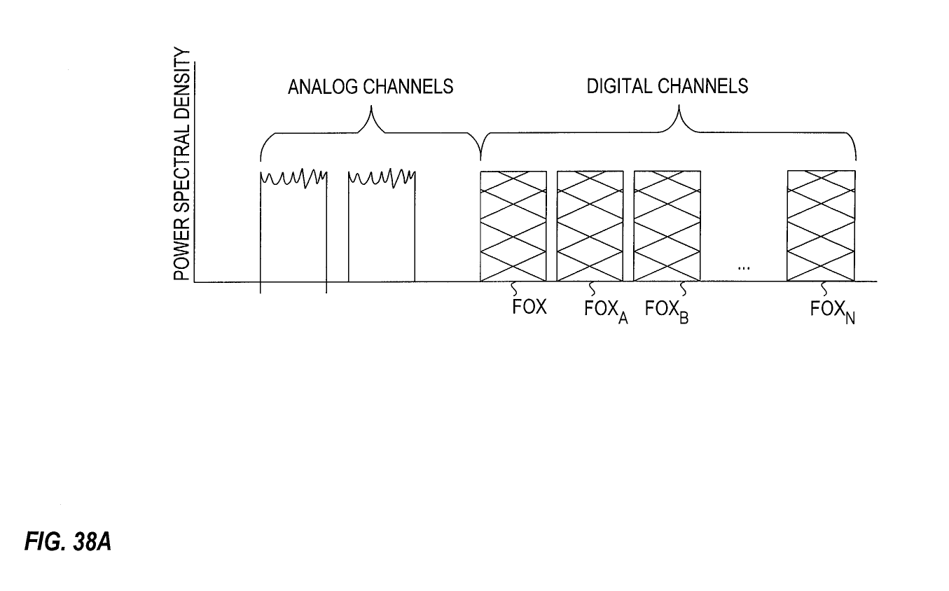

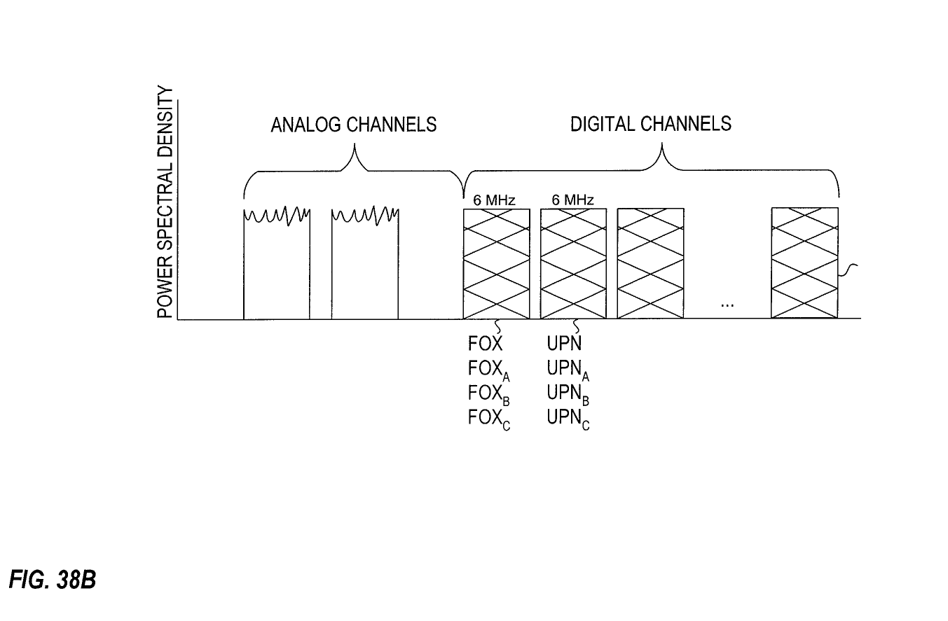

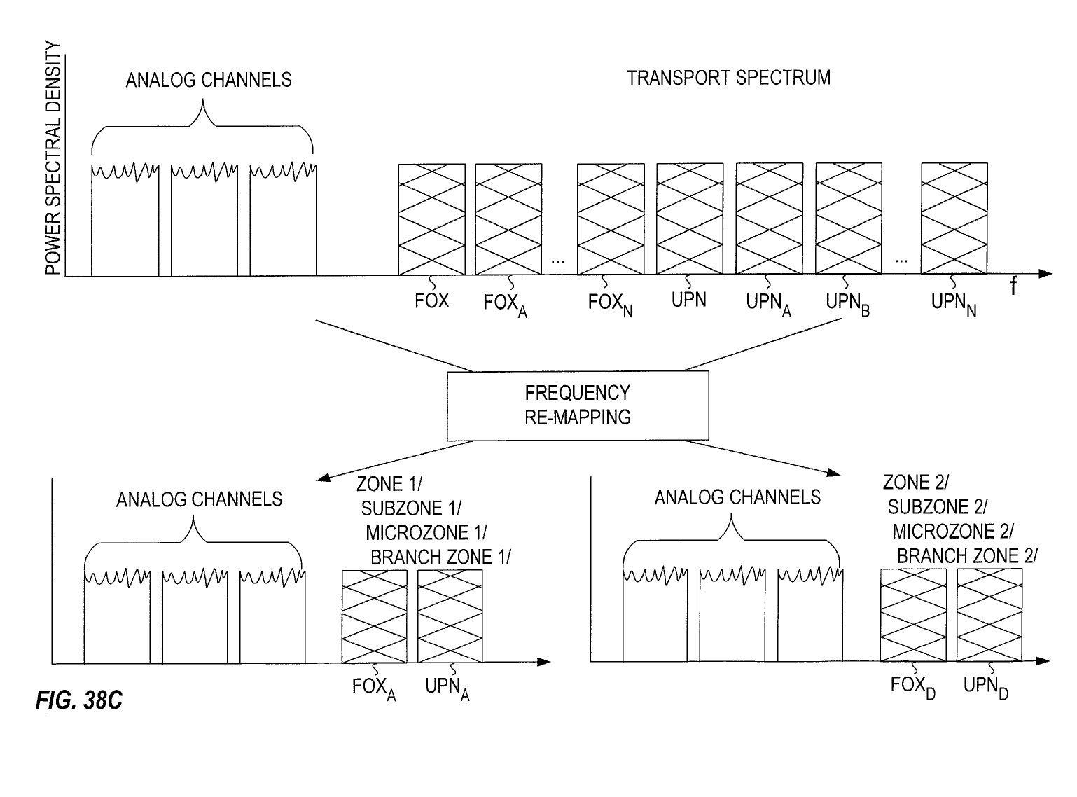

FIG. 37B illustrates an exemplary embodiment of a node receiving multiple presentation streams at different frequencies. As illustrated in FIGS. 38A-C, the presentation streams can be transmitted using several methods and then mapped to the appropriate branch within the node. FIG. 38A illustrates that different digital presentation streams representing the same program stream (network) can be transmitted at different frequencies (Fox-A, Fox-B). FIG. 38B illustrates multiple presentation streams being multiplexed together and transmitted at the same frequency. FIG. 38C illustrates an exemplary remapping of the presentation streams for two branch zones, the first branch zone receiving A presentation streams and the second branch receiving D presentation streams.

Referring back to FIG. 37B, in this embodiment the digital output of the analog/digital separator 3710 is transmitted to a frequency re-mapping module 3770. At the frequency re-mapping module 3370, different digital signals are re-mapped such that multiple versions of the digital channels containing alternate programming or advertising sequences are re-mapped for transmission to the individual branch zones. The different digital signals are then combined with the analog signals and sent to the appropriate branches.

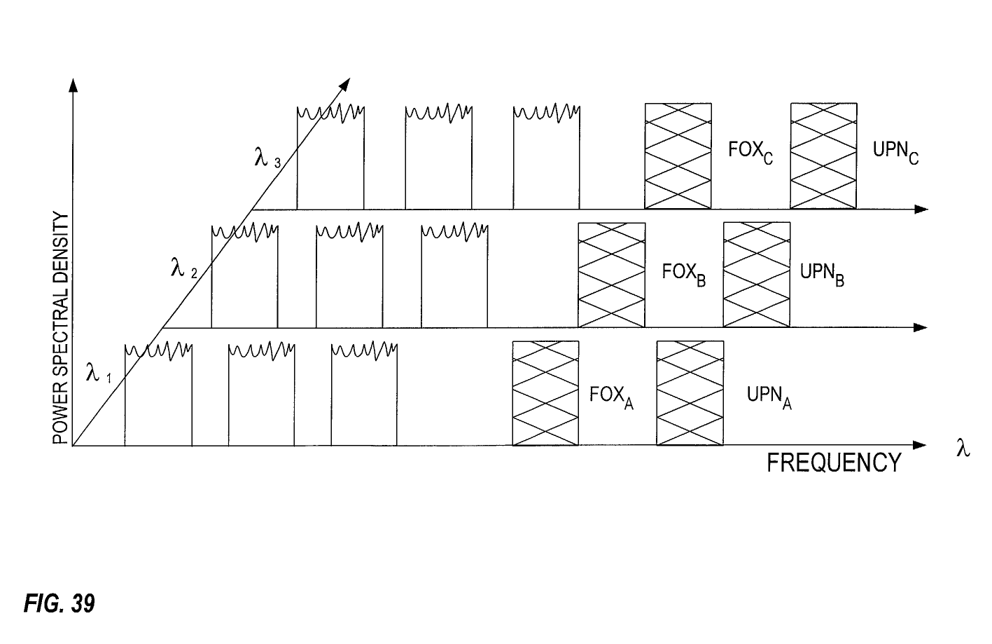

FIG. 37C illustrates an exemplary embodiment of a node receiving multiple presentation streams at different wavelengths. FIG. 39 illustrates different digital presentation streams being transmitted at different wavelengths. In the embodiment of FIG. 37C, a wavelength division demultiplexer 3780 receives signals at multiple wavelengths (λ₁, λ₂, λ₃, λ₄), each wavelength containing a different presentation stream (program stream with targeted ads). The wavelength division demultiplexer 3780 demultiplexes the signals and transmits the appropriate signals to an appropriate O/E 3700. The O/E 3700 transmits the signals either directly, or through amplifiers 3760 to the branch zones.

According to one embodiment, a separate presentation stream can be delivered to each branch based on an aggregate profile of all subscribers connected to that branch (branch profile). However, as one skilled in the art would recognize it would likely be impractical and not beneficial to deliver a separate presentation stream to each branch. Accordingly, in a preferred embodiment, the branches would be clustered. The branches can be clustered using similar methods to those described above with respect to forming clusters of nodes. As one skilled in the art would recognize, it would be possible for some nodes to have branches having multiple presentation streams and others only having a single presentation stream or possibly the default program stream.

According to another embodiment of the present invention, the ad selection and/or insertion is performed at the subscriber end (residence) within a STB, PVR or other devices known to those skilled in the art. As one of ordinary skill in the art would recognize, a STB is a device used as an interface between the CTV system and the subscribers TV. For digital video signals the STB may decode the digital signals to be compatible with the TV. A PVR is basically a STB with memory so that it can record video signals, store data, and perform processing. When used hereinafter, the term STB will represent STBs, PVRs and other equipment capable of performing the same or similar tasks as an STB, and the term PVR will represent PVRs and other equipment capable of performing the same or similar tasks as a PVR.

If the ad selection is to be performed at the subscriber end, the STB may receive multiple presentation streams (FIGS. 38A, 38B and 39) and select the appropriate presentation stream. According to one embodiment, the STB may be programmed to select a certain presentation stream. For example, each STB may be programmed to fall with one of five subscriber groups, each subscriber group corresponding to certain characteristics and/or traits of subscribers (i.e., demographic traits of subscribers). The targeted ads within the presentation streams would correlate with the subscriber groups. Thus, the STB would determine the presentation stream that was assigned to the applicable group and select that presentation stream for display to the subscriber. The annotation identifying which group the presentation stream is identified with could be included within the presentation stream or by other means as would be obvious to one of ordinary skill in the art (discussed in more detail later).

In an alternative embodiment, a correlation between ad profiles for the targeted ads within the presentation streams and the subscriber profile could be performed in order to select the appropriate presentation stream. This embodiment requires that the STB know the profile of the subscriber so that it can perform the correlation. The subscriber profile can be generated within the STB (i.e., viewing characteristics and predicted traits based thereon), may be received from an outside source (i.e., Claritas demographic segment data), or some combination thereof. The subscriber profile may be simple or complex as described previously. The subscriber profile may be stored completely within the STB or may be stored across distributed databases that the STB can access. A PVR may be required to store or generate a complex subscriber profile or to access data related from external sources.

The ad profile may be packaged in a proprietary format or use an existing (or developing) international or industry standard. A proprietary format would be defined as a structure or string of text and/or numeric characters. An international standard for audiovisual metadata, such as the ISO/IEC “Multimedia Content Description Interface” (also know as MPEG7) or the TV-Anytime Forum “Specification Series: S-3 on Metadata”, could also be used to provide the format for the ad profiles. The use of an international standard would facilitate the use of widely available software and equipment for the insertion of ad profile to the audiovisual content. The ad profile can be transported using methods including but not limited to:

as an “Extended Data Service” (XDS) as defined in the Electronic Industries Association's Recommended Practice: EIA-608 on line 21 of an analog video signal (often referred to as the vertical blanking interval (VBI));

as MPEG-2 video “user_data”, as defined in ISO/IEC 13818-2;

as a separate, but associated, MPEG-2 Systems data “PID” as defined in ISO/IEC 13818-1; or

as a sequence of IP (Internet Protocol) packets traveling over the same or different path as the audiovisual content.

The ad profiles can be linked and synchronized with the appropriate content by using the standard synchronization services provided by the MPEG standard or by an alternative “System Clock Reference” carried by both the content and the profile data.

The STB (or PVR depending on the complexity) would correlate the ad profiles and the subscriber profiles. The correlation could be performed in various manners, many of which have previously been discussed. Based on the correlation, the applicable presentation stream is selected for display to the subscriber.

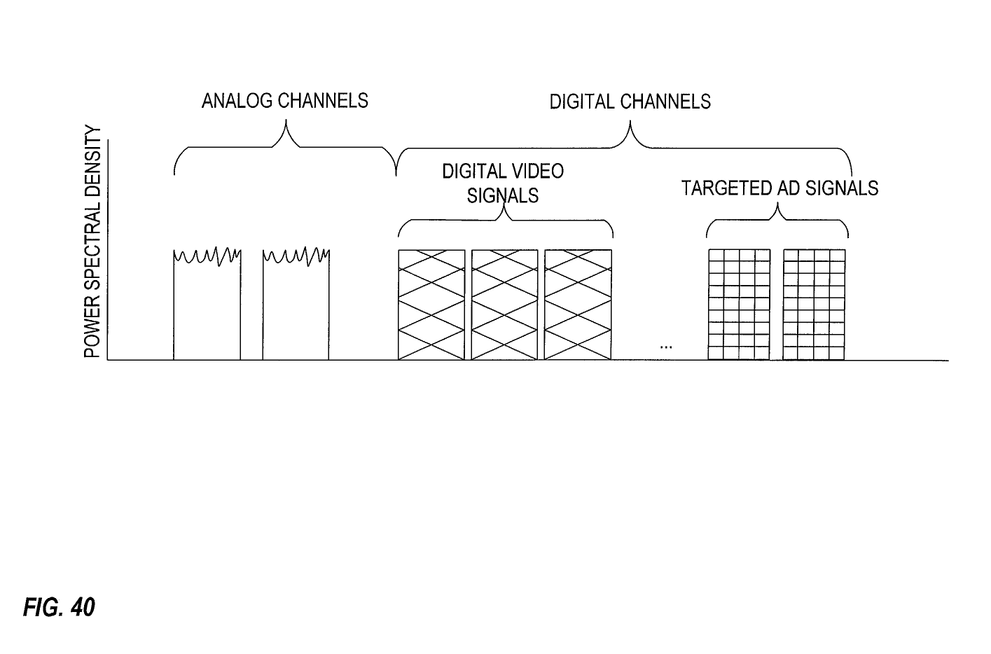

According to another embodiment, the ads may be sent to a PVR on a separate channel. FIG. 40 illustrates transmission of a separate ad channel. A single ad channel may be sent to all subscribers and the PVRs may save those ads that are determined to be relevant to the subscriber based on a correlation between the subscriber profile and an ad profile. Alternatively, targeted ads may be sent to the each PVR (ads that are highly correlated with the subscriber profile) and stored thereon. These ads may be transmitted to the PVRs at late night or early morning hours when bandwidth would be available. Alternatively, the subscribers may be clustered and each cluster of subscribers would receive an applicable ad channel.

In addition to the ads it is likely that an ad queue defining some characteristics of when ads should displayed is also sent to the PVR and stored thereon. Based on the ad queues the ads would be substituted during avails. As one skilled in the art would recognize, the insertion of targeted ads would not be limited to the any particular program and could be inserted at whatever the next avail is. Moreover, there may be multiple queues for various subscribers (or profiles identifying subscribers) within the household. Thus, different ads would be inserted based on what subscriber the PVR determined was viewing the TV based on the profile. The PVR also allows ads to be inserted in recorded programs. In another embodiment, the PVR can insert ads (static or active) into an EPG that the subscriber may be using.

The above detailed description of the current invention concentrated on TV delivery systems. The current invention is not intended to be limited to a TV delivery systems. Rather the concepts of the present invention could be applied to other media such as Internet, radio, publishing, point-of-sale or other media known to those of ordinary skill in the art.

Although this invention has been illustrated by reference to specific embodiments, it will be apparent to those skilled in the art that various changes and modifications may be made, which clearly fall within the scope of the invention. The invention is intended to be protected broadly within the spirit and scope of the appended claims.

What is claimed is:

1. A method for matching advertisements to subscribers, the method comprising:
receiving advertisement profiles that include traits associated with an intended target market for an associated advertisement;
gathering subscriber data from at least one source, wherein the subscriber data is selected from at least a subset of transactional data, public data, private data, and demographic data;
generating subscriber profiles based on at least a subset of gathered subscriber data, wherein the subscriber profiles predict traits about the subscribers without revealing any private data or raw transaction data associated with the subscribers;
correlating the advertisement profiles with the subscriber profiles; and
selecting targeted advertisements based on said correlating.

2. The method of claim 1, further comprising grouping subscribers having similar subscriber profiles.

3. The method of claim 2, further comprising generating a group profile by averaging the subscriber profiles for all subscribers within the group, and wherein said correlating includes correlating the group profiles with the advertisement profiles.

4. The method of claim 1, wherein said correlating includes forming subscriber groups for at least a subset of the advertisement profiles, each subscriber group including subscribers whose subscriber profiles are most similar to a respective advertisement profile.

5. The method of claim 1, wherein said gathering includes monitoring subscriber viewing activities.

6. The method of claim 5, wherein said generating includes aggregating the subscriber viewing activities to develop subscriber viewing characteristics.

7. The method of claim 5, wherein the subscriber viewing activities include at least some subset of channel changes, volume commands, record commands and EPG commands.

8. The method of claim 6, wherein the subscriber viewing characteristics include at least some subset of program preference, network preference, genre preference, volume preference, dwell time, and channel change frequency.

9. The method of claim 8, wherein the subscriber viewing characteristics are broken out by day part.

10. The method of claim 5, wherein said generating includes
retrieving heuristic rules associated with the subscriber viewing activities; and
applying the heuristic rules to the subscriber viewing activities to generate the subscriber profiles, wherein the subscriber profiles predict traits about the subscriber not captured in the subscriber viewing activities.

11. The method of claim 6, wherein said generating further includes
retrieving heuristic rules associated with the subscriber viewing characteristics; and
applying heuristic rules to the subscriber viewing characteristics to generate the subscriber profiles, wherein the subscriber profiles predict traits about the subscriber not captured in the subscriber viewing characteristics.

12. The method of claim 6, wherein said generating further includes
retrieving heuristic rules associated with the subscriber viewing activities and the subscriber viewing characteristics; and
applying the heuristic rules to the subscriber viewing activities and the subscriber viewing characteristics to generate the subscriber profiles, wherein the subscriber profiles predict traits about the subscriber not captured in the subscriber viewing activities or the subscriber viewing characteristics.

13. The method of claim 1, wherein the subscriber profiles include probabilistic demographic traits of the subscribers.

14. The method of claim 1, wherein said generating includes retrieving heuristic rules associated with transactional data gathered for the subscribers, wherein the heuristic rules identify traits likely associated with the subscribers performing those transactions.

15. The method of claim 14, wherein the heuristic rules identify traits not readily identifiable with the transaction data.

16. The method of claim 14, wherein the heuristic rules identify demographic traits.

17. The method of claim 1, wherein said gathering includes gathering information from a plurality of distributed databases.

18. The method of claim 17, wherein the plurality of distributed databases includes at least some subset of viewing characteristics, purchasing characteristics, transaction characteristics, statistical information and deterministic information.

19. The method of claim 1, wherein said generating includes generating subscriber profiles in the form of a ket vector.

20. The method of claim 19, wherein the ket vector is represented by:
$$\vert A >= ( {a}_{1} {ρ}_{1} + {a}_{2} {ρ}_{2} + … {a}_{n} {ρ}_{n} ) + ( {b}_{1} {σ}_{1} + {b}_{2} {σ}_{2} + … {b}_{n} {σ}_{n} ) + … + ( {m}_{1} {ω}_{1} + {m}_{2} {ω}_{2} + … {m}_{n} {ω}_{n} )$$
wherein a₁ through mₙ represent weighting factors and ρ₁ through ωₙ are identification factors selected from at least a subset of viewing characteristics, purchasing characteristics, transaction characteristics, statistical information and deterministic information.

21. The method of claim 19, wherein said correlating includes applying an operator to the subscriber profiles to determine if an advertisement is applicable to associated subscribers.

22. The method of claim 1, wherein said correlating is performed by a secure correlation server.

23. The method of claim 1, wherein said correlating is done by each subscriber.

24. The method of claim 1, further comprising presenting the targeted advertisements to the subscribers.

25. The method of claim 24, wherein said presenting includes presenting the targeted advertisements in avails within program streams.

26. The method of claim 25, wherein the program streams are video program streams.

27. The method of claim 26, wherein the video program streams are television program streams.

28. The method of claim 25, wherein said presenting includes
generating at least one presentation stream for each program stream by inserting targeted advertisements in place of default advertisements within the program streams; and
delivering the presentation streams to the subscribers.

29. The method of claim 28, wherein said generating at least one presentation stream is performed at a cable television head-end.

30. The method of claim 29, wherein said generating at least one presentation stream includes generating a single presentation stream and said delivering includes delivering the single presentation stream to each node connected to the head-end.

31. The method of claim 29, wherein said delivering includes delivering each node connected to the head-end a presentation stream that is targeted thereto.

32. The method of claim 31, wherein each node receives only a single targeted presentation stream for each program stream.

33. The method of claim 29, further comprising grouping nodes having similar profiles together to form a node cluster, and wherein said delivering includes delivering each node within the node cluster the same presentation stream.

34. The method of claim 34, wherein said grouping nodes is not restrained by geographic proximity.

35. The method of claim 33, further comprising generating a node profile by averaging the subscriber profiles for each subscriber connected to the node.

36. The method of claim 29, wherein said delivering includes
delivering multiple presentation streams associated with a single program stream to each node connected to the head-end,
selecting the appropriate presentation stream for each node, and
delivering the appropriate presentation stream to the subscribers connected to each node.

37. The method of claim 36, wherein said delivering multiple presentation streams includes delivering each of the multiple presentation streams at different frequencies, statistically multiplexed together at a single frequency, or at different wavelengths.

38. The method of claim 29, wherein said delivering includes
delivering multiple presentation streams associated with a single program stream to each node connected to the head-end,
selecting the appropriate presentation stream for each branch of each node, and
delivering the appropriate presentation stream to the subscribers connected to each branch.

39. The method of claim 38, wherein
said delivering multiple presentation streams includes delivering each of the multiple presentation streams at different frequencies, and
said selecting includes mapping the frequency of the presentation streams to appropriate branches.

40. The method of claim 38, wherein
said delivering multiple presentation streams includes delivering each of the multiple presentation streams statistically multiplexed together at a single frequency; and
said selecting includes demodulating the statistically multiplexed presentation streams, routing the demodulated presentation streams, and modulating the routed presentation streams to appropriate branches.

41. The method of claim 38, wherein
said delivering multiple presentation streams includes delivering each of the multiple presentation streams at a single frequency and different wavelengths; and
said selecting includes demultiplexing the presentation streams and forwarding the different wavelength presentation streams to appropriate branches.

42. The method of claim 28, wherein said generating at least one presentation stream is performed at a cable television node.

43. The method of claim 28, wherein said delivering includes delivering, to each subscriber, a single targeted presentation stream for each program stream.

44. The method of claim 28, wherein said delivering includes delivering, to each subscriber, a plurality of presentation streams for each program stream, and further comprising selecting the appropriate presentation stream for display to the subscriber.

45. The method of claim 24, wherein said presenting the targeted advertisements includes
delivering a plurality of targeted advertisements to each subscriber; and
inserting the targeted advertisements within advertisement opportunities in delivered program streams.

46. The method of claim 45, wherein said inserting includes inserting the targeted advertisements based on a queue.

47. The method of claim 46, wherein the queue is delivered to the subscriber.

48. The method of claim 47, further comprising storing the targeted advertisements and the queue.

49. The method of claim 48, wherein a PVR receives the program streams, the targeted advertisements, and the queue, stores the targeted advertisements and the queue, and inserts the targeted advertisements in the program streams based on the queue.

50. The method of claim 24, wherein said presenting the targeted advertisements includes
delivering a plurality of advertisements to each subscriber;
delivering an advertisement profile for each of the plurality of advertisements;
determining if each of the advertisements is applicable by correlating the associated advertisement profile with the subscriber profile,
storing the applicable advertisements;
inserting the applicable advertisements within advertisement opportunities in delivered program streams.

51. The method of claim 50, wherein said inserting includes inserting the applicable advertisements based on a queue.

52. The method of claim 50, wherein said presenting the targeted advertisements is performed by a PVR.

53. A method for targeting advertisements to subscribers of a television delivery system, wherein the targeted advertisements are presented in advertisement opportunities within television program streams, the method comprising
monitoring subscriber interactions with a television;
aggregating the monitored subscriber interactions to generate viewing characteristics that identify traits associated with the subscribers but do not identify raw interaction data;
predicting subscriber traits not related to the subscriber interactions with the television by applying heuristic rules associated with the viewing characteristics;
creating subscriber profiles by combining at least some subset of the viewing characteristics and the subscriber traits;
receiving advertisement profiles that identify traits and characteristics of an intended target market of associated advertisements and a minimum correlation threshold;
correlating the advertisement profiles and the subscriber profiles;
identifying the subscribers meeting the correlation threshold for each of the associated advertisements as a target group; and
targeting the associated advertisements to the target groups.

54. The method of claim 53, wherein the predicted subscriber traits include demographic traits.

55. The method of claim 53, further comprising gathering additional subscriber characteristics from at least one external database, and wherein said creating subscriber profiles includes creating subscriber profiles by combining at least some subset of the viewing characteristics and the subscriber traits with at least some subset of the additional subscriber characteristics.

56. The method of claim 55, wherein said additional subscriber characteristics include at least a subset of purchasing and transaction characteristics.

57. The method of claim 53, further comprising gathering additional subscriber traits from at least one external database, and wherein said creating subscriber profiles includes creating subscriber profiles by combining at least some subset of the viewing characteristics and the subscriber traits with at least some subset of the additional subscriber traits.

58. The method of claim 57, wherein said additional subscriber traits include at least a subset of demographic and interest traits.

59. The method of claim 53, further comprising gathering deterministic information about subscriber traits and characteristics from the subscribers via questionnaires or surveys, and wherein said creating subscriber profiles includes creating subscriber profiles by combining at least some subset of the viewing characteristics and the subscriber traits with at least some subset of the deterministic information.

60. The method of claim 53, further comprising generating a node profile by averaging the subscriber profiles for each subscriber connected to the node; and wherein
said correlating includes correlating the advertisement profiles and the node profiles; and
said identifying the subscribers includes identifying the nodes meeting the correlation threshold for each of the associated advertisements as a target group.

61. A method for forming groups of subscribers within a television delivery system for the purpose of receiving targeted advertisements within advertisement opportunities in television program streams, the method comprising
retrieving demographic information for subscribers;
associating the demographic information of the subscribers with particular nodes of the television delivery system;
creating a demographic profile of the nodes by averaging the demographic information for each subscriber connected to the node; and
grouping the nodes based on a correlation associated with the demographic node profiles.

62. The method of claim 61, wherein said grouping includes correlating each demographic node profile with each of the other demographic node profiles and combining the nodes having the most similar correlation into groups.

63. The method of claim 61, wherein said grouping includes correlating each demographic node profile with at least one advertisement profile and combining the nodes having the most correlation with each of the at least one advertisement profiles into groups.

64. The method of claim 61, further comprising
retrieving characteristic information about the subscribers;
associating the characteristic information for the subscribers with the nodes of the television delivery system;
creating a characteristic profile of the nodes by averaging the characteristic information for each subscriber connected to the node; and
creating overall node profiles as an aggregation of at least some subset of the node characteristic profiles and the node demographic profiles; and wherein
said grouping the nodes includes grouping the nodes based on a correlation associated with the overall node profiles.

65. The method of claim 64, wherein said retrieving characteristic information about the subscribers includes
monitoring subscriber interactions with a television; and
aggregating the monitored subscriber interactions to generate viewing characteristics that identify traits associated with the subscribers but do not identify raw interaction data.

66. The method of claim 64, wherein the characteristic information includes at least some subset of viewing characteristics, purchase characteristics and transaction characteristics.

67. A system for targeting ads to one or more subscribers in a privacy protected manner, the system comprising:
one or more databases storing information about subscribers, wherein the information includes at least a subset of transaction data, public data, private data, and demographic data;
a secure profiling server for generating at least one profile for the subscribers based on at least a subset of information stored in the one or more databases, wherein the subscriber profiles predict traits about the subscribers without revealing any private data or raw transaction data associated with the subscribers; and
a secure correlation server for correlating the subscriber profiles with advertisement profiles and selecting targeted advertisements based on said correlating.

68. The system of claim 67, wherein said secure profiling server also forms groups of subscribers having similar profiles.

69. The system of claim 68, wherein said secure profiling server also generates group profiles by averaging the subscriber profiles for all subscribers with a group.

70. The system of claim 67, wherein said secure correlation server also forms groups of subscribers having profiles similar to the advertisement profiles.

71. The system of claim 67, further comprising a viewing characteristics and profiling system for monitoring subscriber viewing activities, aggregating the viewing activities to generate viewing characteristics and storing the viewing characteristics in one of the one or more databases.

72. The system of claim 71, wherein said viewing characteristics and profiling system also applies heuristic rules associated with the viewing characteristics to generate a subscriber profile that predicts traits about the subscriber that are not captured in the viewing characteristics.

72. The system of claim 67, wherein said secure profiling server generates the profiles for the subscribers in the form of a ket vector.

73. The system of claim 72, wherein the ket vector is represented by:
$$\vert A >= ( {a}_{1} {ρ}_{1} + {a}_{2} {ρ}_{2} + … {a}_{n} {ρ}_{n} ) + ( {b}_{1} {σ}_{1} + {b}_{2} {σ}_{2} + … {b}_{n} {σ}_{n} ) + … + ( {m}_{1} {ω}_{1} + {m}_{2} {ω}_{2} + … {m}_{n} {ω}_{n} )$$
wherein a₁ through mₙ represent weighting factors and ρ₁ through ωₙ are identification factors selected from at least a subset of viewing characteristics, purchasing characteristics, transaction characteristics, statistical information and deterministic information.

74. The system of claim 67, further comprising an advertisement insertion server for inserting at least one ad in place of each default ad in program streams to generate at least on presentation stream.

75. An apparatus, coupled to a television, for presenting targeted advertisements to a subscriber on the television, the apparatus comprising:
memory;
an interface to a television network;
a profile processor capable of
monitoring subscriber interactions with the television;
aggregating the monitored subscriber interactions to generate viewing characteristics that identify traits associated with the subscriber but do not identify raw interaction data; and
creating a subscriber profile by combining at least some subset of the viewing characteristics with subscriber traits; and
a correlation processor capable of
correlating ad profiles for the subscriber profile; and
selecting an appropriate advertisements based on the correlation.

76. The apparatus of claim 74, wherein said profile processor is further capable of predicting subscriber traits not related to the subscriber interactions with the television by applying heuristic rules associated with the viewing characteristics.

77. The apparatus of claim 75, wherein said interface receives multiple presentation streams and ad profiles associated with the advertisements within the presentation streams, and said correlation processor selects the appropriate presentation stream.

78. The apparatus of claim 75, wherein said interface receives advertisements and ad profiles on a separate channel, said correlation processor determines which ads are applicable, and said memory stores the applicable ads.

79. The apparatus of claim 75, wherein said interface receives targeted advertisements on a separate channel, said memory stores the targeted ads, and further comprising an ad inserter for inserting the targeted ads.

80. The apparatus of claim 79, wherein said inserter can insert the targeted ads within live broadcasts or recorded programming.
